(19) United States
(12) Patent Application Publication
(10) Pub. No.: US 2026/0340975 A1
(43) Pub. Date: Oct. 29, 2026

(54) OBJECT CLASS IDENTIFICATION AND ENCRYPTION FOR PRIVACY CONTROL AND CONTENT MANAGEMENT

(71) Applicant: QUALCOMM Incorporated, San Diego, CA (US)

(72) Inventor: Khalid TAHBOUB, San Diego, CA (US)

(21) Appl. No.: 19/659,792

(22) Filed: Apr. 27, 2026

Related U.S. Application Data
(60) Provisional application No. 63/796,937, filed on Apr. 29, 2025.

(51) Int. Cl. G06V 10/25; G06T 7/11; H04L 9/06

(52) U.S. Cl. CPC G06V 10/25; G06T 7/11; H04L 9/0618

(57) ABSTRACT

A device includes one or more processors configured to obtain input media data including an instance of an object class and identify a region of interest (ROI) corresponding to the instance of the object class. The one or more processors are configured to extract and encrypt ROI content from the ROI to generate encrypted ROI content and mask at least a portion of the ROI to generate a masked image frame. The one or more processors are also configured to generate output media data that includes: an encoded masked image frame corresponding to the masked image frame; an encoded encrypted ROI frame corresponding to the encrypted ROI content; and content protection data. The content protection data includes an encryption indicator that indicates the output media data includes the encrypted ROI content. The encoded encrypted ROI frame is indicated as a non-display frame by a non-display indicator.

### I. CROSS-REFERENCE TO RELATED APPLICATIONS

The present application claims priority from the commonly owned U.S. Provisional Patent Application No. 63/796,937, filed Apr. 29, 2025, entitled “OBJECT CLASS IDENTIFICATION AND ENCRYPTION FOR PRIVACY CONTROL AND CONTENT MANAGEMENT”, the content of which is incorporated herein by reference in its entirety.

### II. FIELD

The present disclosure is generally related to identification and encryption of media content.

### III. Description of Related Art

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

The advances in technology have also made digital cameras ubiquitous to modern life. The prevalence of digital cameras and the availability of low-cost memory devices to store images and videos has resulted in a large amount of image and video content. The ability to generate, store, and share the image and video content has increased privacy and security concerns. For example, privacy concerns may be related to an individual's right to his or her personal information, likeness or image, or a combination thereof. As another example, privacy concerns have increased in view of the potential of personal content being used to train artificial intelligence models. Various regulations have been enacted to address such privacy concerns and that detail storage and sharing of images or video collected in certain circumstances, such as images or video collection associated with autonomous driving, dashboard camera, surveillance systems, in-cabin monitoring or personal use. However, the assumption of privacy varies based on different regulations and in different countries.

One technique that has been used comply with the various regulations includes masking content to be protected. For example, traditional masking can include encoding an input video into a bitstream and providing manual or automated annotation to the bitstream to generate processed pixel data (e.g., YUV values) that is then encoded into a second bitstream having masked content. Another technique that has been used includes applying an encryption method, such as advanced encryption standard (AES) encryption. For example, an input video is encoded into a bitstream, a fragment/scramble operation is performed on the bitstream to generate bitstream segments, and asymmetric encryption is performed, based on or using a key (e.g., a secret key), on the bitstream segments to generate an encrypted bitstream. However, the conventional techniques can often encrypt more content (e.g., a whole bitstream) than is needed to comply with a regulation, which results in high computational complexity and power consumption. Additionally, the conventional techniques do not allow for both authorized and non-authorized access of encrypted content using the same encrypted bitstream (e.g., a single bitstream having encrypted and/or masked content).

### IV. Summary

According to one implementation of the present disclosure, a device includes one or more processors configured to obtain input media data including an instance of an object class and identify a region of interest (ROI) corresponding to the instance of the object class. The one or more processors are configured to extract and encrypt ROI content from the ROI to generate encrypted ROI content. The one or more processors are configured to mask at least a portion of the ROI to generate a masked image frame.

The one or more processors are also configured to generate output media data that includes: an encoded masked image frame corresponding to the masked image frame; an encoded encrypted ROI frame corresponding to the encrypted ROI content; and content protection data. The content protection data includes an encryption indicator that indicates the output media data includes the encrypted ROI content. The encoded encrypted ROI frame is indicated as a non-display frame by a non-display indicator.

According to another implementation of the present disclosure, a method includes obtaining input media data including an instance of an object class and identifying a region of interest (ROI) corresponding to the instance of the object class. The method includes extracting and encrypting ROI content from the ROI to generate encrypted ROI content. The method includes masking at least a portion of the ROI to generate a masked image frame. The method also includes generating output media data that includes: an encoded masked image frame corresponding to the masked image frame; an encoded encrypted ROI frame corresponding to the encrypted ROI content; and content protection data. The content protection data includes an encryption indicator that indicates the output media data includes the encrypted ROI content. The encoded encrypted ROI frame is indicated as a non-display frame by a non-display indicator.

According to another implementation of the present disclosure, a non-transitory computer-readable medium stores instructions that are executable by one or more processors to cause the one or more processors to obtain input media data including an instance of an object class and identify a region of interest (ROI) corresponding to the instance of the object class. The instructions further cause the one or more processors to extract and encrypt ROI content from the ROI to generate encrypted ROI content. The instructions further cause the one or more processors to mask at least a portion of the ROI to generate a masked image frame. The instructions further cause the one or more processors to generate output media data that includes: an encoded masked image frame corresponding to the masked image frame; an encoded encrypted ROI frame corresponding to the encrypted ROI content; and content protection data. The content protection data includes an encryption indicator that indicates the output media data includes the encrypted ROI content. The encoded encrypted ROI frame is indicated as a non-display frame by a non-display indicator.

According to another implementation of the present disclosure, an apparatus includes means for obtaining input media data including an instance of an object class and identifying a region of interest (ROI) corresponding to the instance of the object class. The apparatus includes means for extracting and encrypting ROI content from the ROI to generate encrypted ROI content. The apparatus includes means for masking at least a portion of the ROI to generate a masked image frame. The apparatus also includes means for generating output media data that includes: an encoded masked image frame corresponding to the masked image frame; an encoded encrypted ROI frame corresponding to the encrypted ROI content; and content protection data. The content protection data includes an encryption indicator that indicates the output media data includes the encrypted ROI content. The encoded encrypted ROI frame is indicated as a non-display frame by a non-display indicator.

According to another implementation of the present disclosure, a device includes one or more processors configured to obtain output media data associated with media data. The output media data includes an encoded encrypted ROI frame corresponding to encrypted ROI content associated with a region of interest (ROI) of the media data that includes an instance of an object class; an encoded masked image frame corresponding to a masked version of the media data; and content protection data. The content protection data includes an encryption indicator that indicates the output media data includes the encrypted ROI content. The one or more processors are configured to identify the encryption indicator. The one or more processors are further configured to, based on identification of the encryption indicator, decrypt the encrypted ROI content to obtain the ROI of the media data and modify the masked version of the media data to include the ROI of the media data. The encoded encrypted ROI frame is indicated as a non-display frame by a non-display indicator.

According to another implementation of the present disclosure, a method includes obtaining output media data associated with media data. The output media data includes an encoded encrypted ROI frame corresponding to encrypted ROI content associated with a region of interest (ROI) of the media data that includes an instance of an object class; an encoded masked image frame corresponding to a masked version of the media data; and content protection data. The content protection data includes an encryption indicator that indicates the output media data includes the encrypted ROI content. The method includes identifying the encryption indicator. The method includes decrypting, based on identification of the encryption indicator, the encrypted ROI content to obtain the ROI of the media data. The method also includes modifying the masked version of the media data to include the ROI of the media data. The encoded encrypted ROI frame is indicated as a non-display frame by a non-display indicator.

According to another implementation of the present disclosure, a non-transitory computer-readable medium stores instructions that are executable by one or more processors to cause the one or more processors to obtain output media data associated with media data. The output media data includes an encoded encrypted ROI frame corresponding to encrypted ROI content associated with a region of interest (ROI) of the media data that includes an instance of an object class; an encoded masked image frame corresponding to a masked version of the media data; and content protection data. The content protection data includes an encryption indicator that indicates the output media data includes the encrypted ROI content. The instructions further cause the one or more processors to identify the encryption indicator. The instructions also cause the one or more processors to, based on identification of the encryption indicator, decrypt the encrypted ROI content to obtain the ROI of the media data, and modify the masked version of the media data to include the ROI of the media data. The encoded encrypted ROI frame is indicated as a non-display frame by a non-display indicator.

According to another implementation of the present disclosure, an apparatus includes means for obtaining output media data associated with media data. The output media data includes an encoded encrypted ROI frame corresponding to encrypted ROI content associated with a region of interest (ROI) of the media data that includes an instance of an object class; an encoded masked image frame corresponding to a masked version of the media data; and content protection data. The content protection data includes an encryption indicator that indicates the output media data includes the encrypted ROI content. The apparatus also includes means for identifying the encryption indicator. The apparatus further includes means for decrypting, based on identification of the encryption indicator, the encrypted ROI content to obtain the ROI of the media data. The apparatus includes means for modifying the masked version of the media data to include the ROI of the media data. The encoded encrypted ROI frame is indicated as a non-display frame by a non-display indicator.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of an example of a system to identify and encrypt media content, in accordance with one or more aspects of the present disclosure.

FIG. 2 is a diagram of examples of image frames to illustrate operations associated with the system of FIG. 1, in accordance with one or more aspects of the present disclosure.

FIG. 3 is a diagram of an example of encoded output data to illustrate operations associated with the system of FIG. 1, in accordance with one or more aspects of the present disclosure.

FIG. 4A is a diagram of examples of encoded output data to illustrate operations associated with the system of FIG. 1, in accordance with one or more aspects of the present disclosure.

FIG. 4B is a diagram of an example of a bitstream of encoded output data to illustrate operations associated with the system of FIG. 1, in accordance with one or more aspects of the present disclosure.

FIG. 5 is a diagram of an illustrative example of a processor of the system of FIG. 1, in accordance with one or more aspects of the present disclosure.

FIG. 6 is a diagram of examples of image frames to illustrate operations associated with the system of FIG. 1, in accordance with one or more aspects of the present disclosure.

FIG. 7A is a block diagram of an example of a system to decode media content, in accordance with one or more aspects of the present disclosure.

FIG. 7B is a diagram of an example of operations that may be performed at the system of FIG. 7A.

FIGS. 8A, 8B, 8C, and 8D are block diagrams to illustrate operations associated with the system of FIG. 7A.

FIG. 9 is a block diagram of an example of a system to encrypt and decrypt media content, in accordance with one or more aspects of the present disclosure.

FIG. 10 is a diagram of an example of an integrated circuit operable to encrypt or decrypt media content, in accordance with some examples of the present disclosure.

FIG. 11 is a diagram of a mobile device operable to encrypt or decrypt media content, in accordance with some examples of the present disclosure.

FIG. 12 is a diagram of a wearable electronic device operable to encrypt or decrypt media content, in accordance with some examples of the present disclosure.

FIG. 13 is a diagram of a voice-controlled speaker system operable to encrypt or decrypt media content, in accordance with some examples of the present disclosure.

FIG. 14 is a diagram of a camera operable to encrypt or decrypt media content, in accordance with some examples of the present disclosure.

FIG. 15 is a diagram of a headset, such as a virtual reality, mixed reality, or augmented reality headset, operable to encrypt or decrypt media content, in accordance with some examples of the present disclosure.

FIG. 16 is a diagram of a mixed reality or augmented reality glasses device operable to encrypt or decrypt media content, in accordance with some examples of the present disclosure.

FIG. 17 is a diagram of a first example of a vehicle operable to encrypt or decrypt media content, in accordance with some examples of the present disclosure.

FIG. 18 is a diagram of a second example of a vehicle operable to encrypt or decrypt media content, in accordance with some examples of the present disclosure.

FIG. 19 is a diagram of an example of a method of encryption of media content, in accordance with some aspects of the present disclosure.

FIG. 20 is a diagram of an example of a method of decryption of media content, in accordance with some aspects of the present disclosure.

FIG. 21 is a block diagram of an illustrative example of a device that is operable to identify and encrypt media content, in accordance with one or more aspects of the present disclosure.

### VI. DETAILED DESCRIPTION

The above-described problems associated with encryption of a whole bitstream and/or failure to allow for both authorized and non-authorized access of encrypted content using the same encrypted bitstream are solved by encrypting at least a portion of a bitstream and including content protection data, such as bitstream metadata, frame header data, or both, that enable devices receiving the bitstream to reconstruct a version of the content in which the protected content is decrypted for playout, or another version in which the protected content remains masked during playout, based on whether access to the protected content is authorized or non-authorized.

The present disclosure provides systems, devices, apparatus, methods, and computer-readable media for encryption or decryption of media content for media content systems, such as encryption or decryption of at least a portion of the media content that includes an object. Some aspects more specifically relate to detecting an instance of an object class (e.g., a person, a license plate, etc.) within input data. Based on detection of the instance of the object class, a portion of input media data that includes the instance is encrypted to generate encrypted media data, and the portion of the input media is also masked (e.g., in the input media data) to generate a masked version of the input media data. The portion of the input media data may correspond to a region of interest (ROI) identified based on the instance of the object class. The ROI content (also referred to herein as data from the ROI or the portion) may be extracted and encrypted to generate encrypted ROI content. The masked version of the input media data may also be referred to herein as a masked image frame. Output media data, such as a bitstream, is generated that includes the masked version of the input media data, the encrypted media data, and content protection data. The content protection data includes an encryption indicator that indicates whether the output media data includes the encrypted media data which may be decrypted and combined with masked version of the input media data to obtain the input media. The content protection data can also include encryption parameters, frame identifiers, region of interest (ROI) identifiers, segmentation data, non-display indicators, etc., to enable reconstruction and playout of the input media data, the masked version of the input media, or both.

Particular implementations of the subject matter described in this disclosure can be implemented to realize one or more of the following technical advantages. In some aspects, the present disclosure provides techniques for identifying one or more ROIs of sensitive content in the input media data, and encrypting the identified ROIs for privacy control and content management. In some examples, the techniques may also mask the sensitive content of the input media data to generate a masked version that can be displayed by one or more device or users that do not have authorization or access to the sensitive content (e.g., the encrypted data). In some aspects, the encryption indicator indicates that sensitive content may be recovered and combined with the masked content to generate (e.g., recreate) the original content by one or more devices or users that have authorization or access to the sensitive content and that have the key. In some embodiments, the techniques may be applied to provide automatic sensitive content (partial video) encryption while the video is captured for the first time. The partial video encryption, through use of the content protection data, can allow for both authorized and non-authorized access of encrypted content using the same encrypted bitstream, thus reducing the amount of transmission bandwidth and storage capacity that would otherwise be required to accommodate receipt, storage, and playback of both authorized and non-authorized versions of the media data at a device and, as a result, improving the efficiency of the device by enabling provision of both authorized and non-authorized versions using fewer resources as compared to conventional devices. Unlike systems that selectively encrypt application data fields or network message payloads, the disclosed techniques integrate encryption within a media processing and encoding pipeline, and operate on perceptually meaningful regions of image or video content.

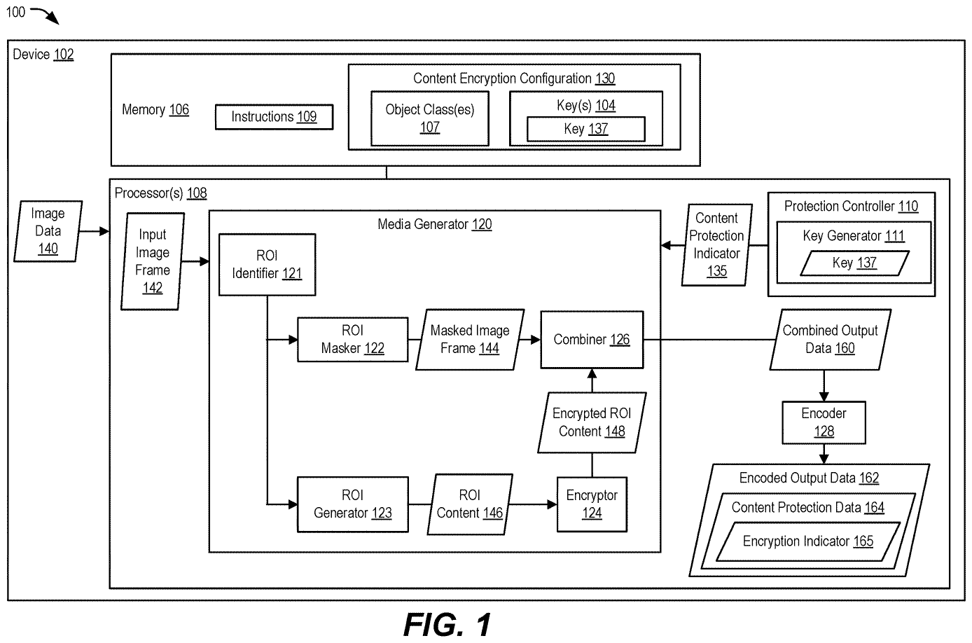

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein—e.g., when no particular one of the features is being referenced, the reference number is used without a distinguishing letter. However, when one particular feature of multiple features of the same type is referred to herein, the reference number is used with the distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data.” The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 is a block diagram of an example of a system to identify and encrypt media content, in accordance with one or more aspects of the present disclosure. The system 100 includes a device 102 that is configured to or is operable to identify and encrypt media content.

The device 102 includes, or is coupled to, a memory 106 (e.g., a memory device) and one or more processors 108 (collectively referred to herein as the “processor 108”). The memory 106 may include one or more memory devices, such as a single memory or multiple different memory devices (of the same type or of different types).

The memory 106 is configured to store instructions 109 and a content encryption configuration 130. The instructions 109, when executed by the processor 108, cause the processor 108 to perform one or more operations as described herein. The content encryption configuration 130 may be associated with or indicate content (e.g., sensitive content) to be protected. The content encryption configuration 130 may be determined by a user of the device 102, by another user (e.g., a contact of the user of the device 102), by a provider (e.g., a service provider or OEM) associated with the device 102, by a company or entity, based on a regulation, or a combination thereof. In some embodiments, the content encryption configuration 130 may be associated with media content generated in association with a surveillance system (e.g., a body camera), a personal recording (e.g., recorded in a public space), a vehicle (e.g., for autonomous driving, dashboard camera, or in-cabin monitoring), or a combination thereof, as illustrative, non-limiting examples.

The content encryption configuration 130 includes one or more object classes 107 (collectively referred to herein as the “object class 107”) and one or more keys 104 (collectively referred to herein as the “key 104”). The object class 107 indicates a class or type of one or more object to be identified or detected within media content. The media content, such as input media content, may include image data, an image frame, video data (e.g., a sequence of multiple image frames), audio data, or a combination thereof. The object class 107 may include or be associated with sensitive, private, or confidential content to be protected. In some embodiments, the class or type of the one or more objects may include or indicate a human body, a particular individual, a face, a voice, a word or phrase, a sound, a license plate, an animal, a vehicle, a document, a display or monitor, a whiteboard, or a combination thereof, as illustrative, non-limiting examples. In some embodiments, the object class 107 may also include or indicate a model, such as a neural network model, AI model or ML model, to be used to identify or detect a corresponding class or type of one or more objects within media content.

The key 104 may include or correspond a respective object class 107. The key 104 may be configured to encrypt at least a portion of media content that includes or is associated with an instance of the object class 107, to encrypt another key, decrypt the other encrypted key, or a combination thereof. In an example in which the key 104 includes multiple keys, the key 104 may include a first key (e.g., an encryption key) configured to encrypt at least a portion of media content that includes or is associated with an instance of the object class 107, a second key (e.g., a public key) configured to encrypt information (such as the first key), a third key (e.g., a private key) configured to decrypt information encrypted using the second key, or a combination thereof.

In some examples, the memory 106 stores other information or data, such as media content. The media content can include or indicate audio content, video content, or a combination thereof. In some examples, the stored media content includes at least an encrypted portion.

The processor 108 includes a protection controller 110, a media generator 120, and an encoder 128. Each of the protection controller 110, the media generator 120, and the encoder 128, or a portion thereof, may be implemented by the processor 108 executing instructions (e.g., software), dedicated hardware (e.g., circuitry), or a combination thereof. It is noted that in some embodiments, two or more of the protection controller 110, the media generator 120, or the encoder 128 may be combined. For example, the media generator 120 may include the protection controller 110, the encoder 128, or both.

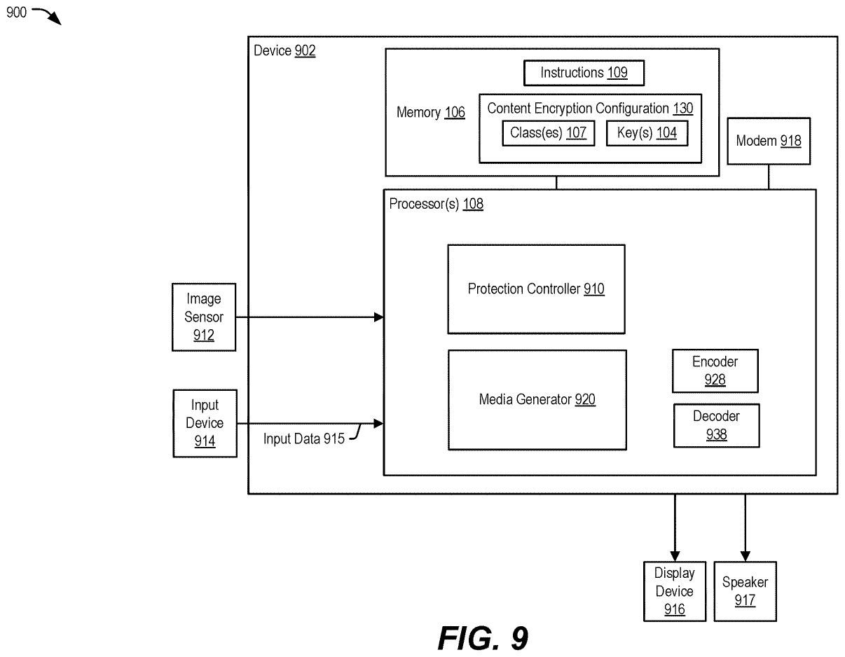

The protection controller 110 is configured to provide a content protection indicator 135 to the media generator 120 for the media generator 120 to implement an encryption requirement. The content protection indicator 135 may indicate the encryption requirement that includes the object class 107, the key 104 (e.g., an encryption key, a public key, or a private key), or a combination thereof, to be applied by the media generator 120 to identify or detect, and encrypt, media content to be protected. In some embodiments, the content protection indicator 135 may indicate a list of object classes 107 and, for each object class, a respective key 104 associated with an instance of the object class. Additionally, or alternatively, the protection controller 110 is configured to program or configure the encoder 128 with the object class 107, the key 104 (e.g., an encryption key, a public key, or a private key), or a combination thereof. In some implementations, the protection controller 110 may generate the content protection indicator 135 based on an input (as described with reference to FIG. 9), location data that indicates a location of the device 102, the content encryption configuration 130 or a status thereof, or a combination thereof.

In some embodiments, the protection controller 110 includes a key generator 111. The key generator 111 may be configured to generate a key 137, such as an encryption key for a respective object class 107. The protection controller 110 may store the key 137 at the memory 106, indicate the key 137 by the content protection indicator 135, or a combination thereof. It is noted that although the embodiment of the device 102 of FIG. 1 is described as including the key generator 111, in other embodiments, the protection controller 110 may not include the key generator 111.

The media generator 120 is configured to identify and encrypt media data based on the content protection indicator 135—e.g., in accordance with a content encryption configuration 130 indicated by the content protection indicator 135. The media generator 120 includes a region of interest (ROI) identifier 121, an ROI masker 122, an ROI generator 123, an encryptor 124, and a combiner 126.

The ROI identifier 121 is configured to process media content to detect the object class 107 included in media content, such as an input image frame 142, and identify an ROI associated with the detected object class. In an example, the ROI identifier 121 processes media content to detect when one or more instances of the object class 107, such as one or more objects identified as having the object class 107, are in the media content; to illustrate, the ROI identifier may include a face detector configured to detect a person's face—e.g., an instance of a “face” object class—in the media content. The ROI may include at least a portion of an image frame, or a time period or frequency of an audio signal. For example, the ROI may include an outline of the detected object or a region that is larger than the detected object.

In some embodiments, to detect the object class 107 and/or to identify the ROI, the ROI identifier 121 may use a model (e.g., a neural network model, an AI model, or an ML model), a histogram of gradient methods combined with support vector machine (SVM), a bounding box output, or dense pixel segmentation, as illustrative, non-limiting examples. In some embodiments, the ROI identifier 121 may be configured to generate position data that indicates a position of the ROI and/or a detected object class within the media content. As illustrative, non-limiting examples, the position data may include or indicate a pixel coordinate, multiple pixel coordinates, or a bounding box. Additionally, or alternatively, the ROI identifier 121 may be configured to perform a segmentation operation to generate segmented data that includes or indicates a portion of the media content, where the portion includes a detected instance of the object class 107. For example, the segmentation operation can be configured to identify, in an image, which pixels belong to an identified object (and which do not) and to generate segmentation data that includes, for each pixel identified as belonging to the object, an indication that the pixel is part of the object. In a particular embodiment, the segmentation data includes a segmentation frame having pixels of a first value (e.g., 255, or an all-1 value) to indicate pixels in the image that belong to a detected object class 107 and pixels of a second value (e.g., 0, or an all-0 value) to indicate pixels in the image that do not belong to the detected object class 107.

The ROI masker 122 is configured to mask the ROI (e.g., the portion of the media content) identified by the ROI identifier 121. The ROI masker 122 may mask the ROI using one or more techniques (e.g., a mask type), such as blurring using uniform kernels or gaussian kernels, masking the region a solid color (e.g., black or white), masking the region with a pattern (e.g., stripes), masking the region with an encrypted version of the ROI (e.g., encrypted pixel values that appear to be random noise in the ROI), or a combination thereof. In some embodiments, the ROI masker 122 masks the ROI in the media content to generate a masked version of the media content. In some embodiments, the ROI masker 122 is configured to receive a mask indicator which indicates a mask technique or a mask type to be used by the ROI masker 122. The mask indicator may be received from the protection controller 110. For example, the content protection indicator 135 may include or indicate the mask indicator.

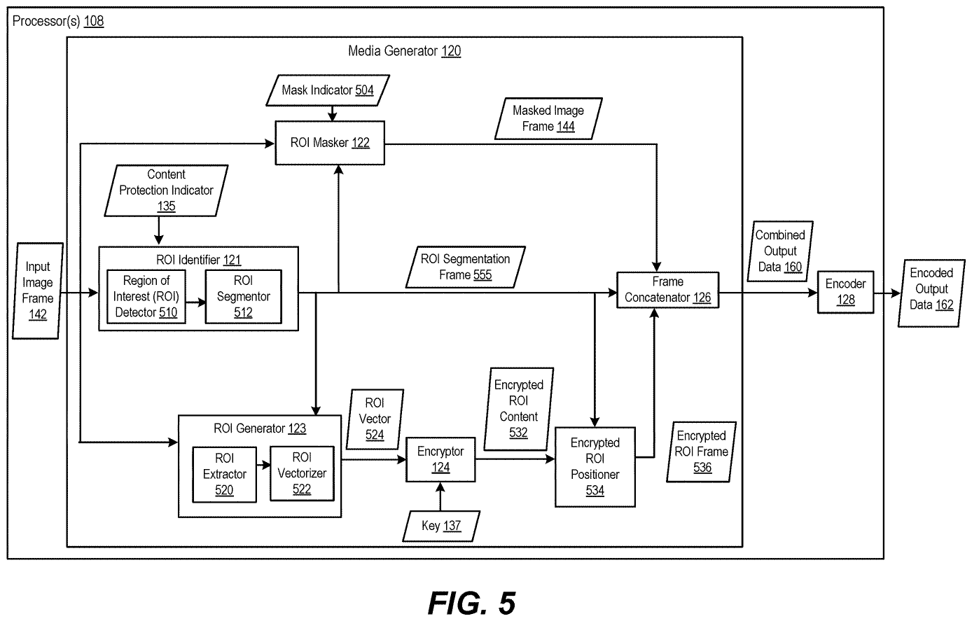

The ROI generator 123 is configured to obtain ROI content 146 included in the ROI (e.g., the portion of the media content) identified by the ROI identifier 121. For example, the ROI generator 123 may copy or extract the ROI content 146 from the media content based on the ROI identified by the ROI identifier 121. One or more operations that may be performed by the ROI generator 123 to obtain the ROI content 146 are described further herein at least with reference to FIG. 5. In some embodiments, the ROI content 146 includes a vectorized representation (e.g., a one-dimensional array of data (vector)) that is suitable for encryption.

The encryptor 124 is configured to encrypt the ROI content 146 to generate encrypted ROI content 148. For example, the encryptor 124 may encrypt the ROI content 146 based on or using the key 104 (e.g., the key 137). In some embodiments, the encryptor 124 uses a format preserving encryption (input and output have the same size) to generate the encrypted ROI content 148 based on the ROI content 146. Illustrative, non-limiting examples of a format preserving encryption include format-preserving, Feistel-based encryption (FFX), such as FF1 or FF3. In some embodiments, one or more encryption parameters, such as a block size or an alphabet, to be used by the encryptor 124 may be obtained from the content encryption configuration 130, the content protection indicator 135, or a combination thereof.

The combiner 126 is configured to combine the masked image frame 144, the encrypted ROI content 148, position data or segmentation data associated with a position of the portion of the media content that corresponds to the ROI, one or more encoder parameters, or a combination thereof, to generate combined output data 160. In some embodiments, to generate the combined output data 160, the combiner 126 is configured to concatenate the masked image frame 144, the encrypted ROI content 148, position data or segmentation data associated with a position of the portion of the media content that corresponds to the ROI, one or more encoder parameters, or a combination thereof. It is noted that when the media content includes video content, masked image frames (e.g., the masked image frame 144) and encrypted ROI content (e.g., the encrypted ROI content 148) may be temporally concatenated and provided to the encoder 128 for processing and/or compression.

The encoder 128 is configured to receive the combined output data 160 and generate encoded output data 162. In some embodiments, the encoder 128 may encode the combined output data 160 based on the content protection indicator 135, one or more encoder parameters received from the protection controller 110 and/or the media generator 120, or a combination thereof. In a particular embodiment, the encoder 128 uses a higher-compression, lossy encoding to encode the masked image frame 144 in the combined output data 160 and switches to a lower-compression, lossless encoding technique to encode the encrypted ROI content 148 in the combined output data 160.

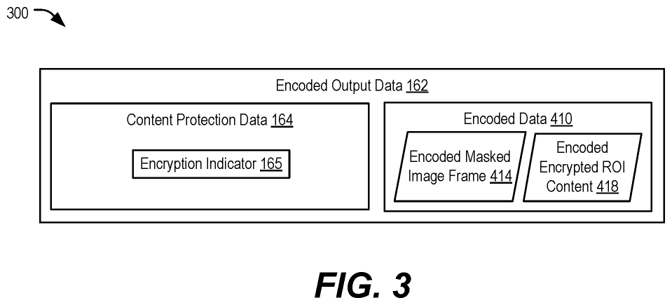

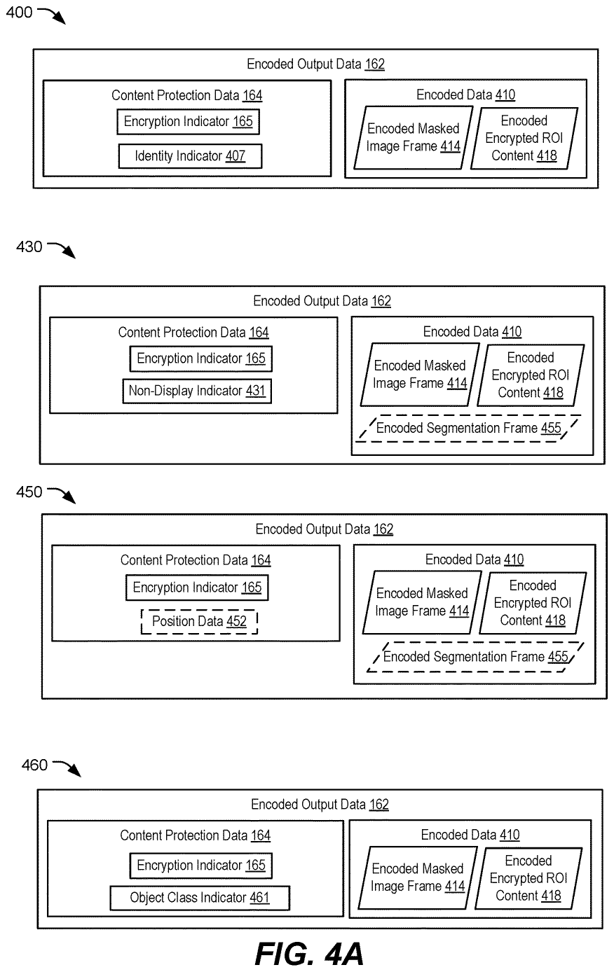

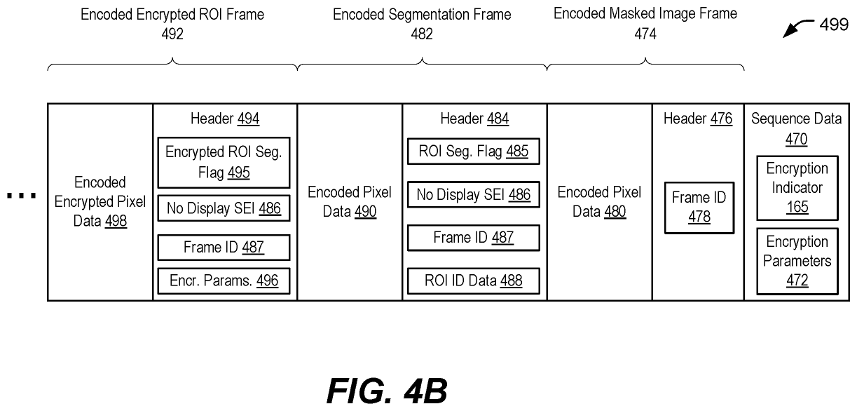

In some embodiments, the encoded output data 162 includes encoded data that includes or corresponds to the masked image frame 144, the encrypted ROI content 148, the combined output data 160, or a combination thereof. Examples of the encoded data are described further herein at least with reference to FIGS. 3-4.

In a particular embodiment, the encoded output data 162 includes content protection data 164. The content protection data 164 may include one or more indicators, such as an encryption indicator 165. The encryption indicator 165 may indicate that the encoded output data 162 includes or indicates the encrypted ROI content 148 (e.g., encrypted media data). In an illustrative example, the encryption indicator 165 includes or corresponds to a flag that indicates the presence of encrypted data in the encoded output data 162. Additionally, or alternatively, the encryption indicator 165 may indicate one or more encryption parameters. The one or more encryption parameters may include or indicate an encryption type, a maximum block size, an alphabet size, one or more formatting details, a number of object classes, or a combination thereof. In some embodiments, the content protection data 164 includes the encryption indicator 165 and other information, such as an identity indicator, a non-display indicator, position data, an object class indicator, or a combination thereof, as described further herein at least with reference to FIGS. 4A and 4B.

In some embodiments, the encoded output data 162 includes a bitstream. The bitstream may be compliant with a standard, such as H.264/MPEG-4 AVC (Advanced Video Coding), H.265/HEVC (High Efficiency Video Coding), MPEG-2, MPEG-1, VC-1 (Windows Media Video). The bitstream includes data associated with the encoded output data 162, a header, metadata, segmentation data (e.g., a segmentation frame), the encrypted ROI content 148, the masked image frame 144, the encryption indicator 165, the key 137 (or an encrypted version of the key 137 encrypted based on a public key), or a combination thereof.

In some embodiments, the encoded output data 162 is included in or corresponds to a bitstream, such as the bitstream 499 described further herein with reference to FIG. 4B. In other embodiments, the encoded output data 162 is included in or corresponds to a media container, such as an MPEG-4 (MP4) container, an Audio Video Interleave (AVI) container, an MPEG transport stream container, or another multimedia container format. The media container may be configured to encapsulate components of the encoded output data 162, such as one or more encoded masked image frames (e.g., the encoded masked image frame 414 described further herein with reference to FIG. 3 and FIG. 4A or the encoded masked image frame 474 described further herein with reference to FIG. 4B), encrypted data such as one or more encoded encrypted ROI frames (the encoded encrypted ROI content 418 described further herein with reference to FIG. 3 and FIG. 4A or the encoded encrypted pixel data 498 described further herein with reference to the encoded encrypted ROI frame 492 of FIG. 4), the content protection data 164, segmentation data such as one or more encoded segmentation frames (e.g., the encoded segmentation frame 455 described further herein with reference to FIG. 4A or the encoded segmentation frame 482 described further herein with reference to FIG. 4B), or a combination thereof.

In an illustrative example, the media container includes multiple tracks (or, in some container formats, multiple streams), such that a first track of the media container includes the encoded masked image frame 414 and a second track of the media container includes the encoded encrypted ROI content 418. Additionally, or alternatively, the content protection data 164, the segmentation data, or both, may be included in a metadata field of the media container, a supplemental track of the media container, an embedded data field of the media container, or a combination thereof. In some embodiments, the media container provides an alternative to including the encrypted ROI content 148, the segmentation data, or the content protection data 164 within a codec-level bitstream (e.g., the bitstream 499 of FIG. 4B), such that the data associated with encryption and content protection is carried at a container level rather than within codec-compliant frame headers or sequence data. In some embodiments in which the encoded output data 162 includes the media container, the media generator 120, the encoder 128, or both, are configured to operate at a container level to organize the masked image frame 144, the encrypted ROI content 148, the segmentation data, and the content protection data 164 as distinct data elements (e.g., tracks, metadata entries, or embedded data fields) within the media container. Use of the media container can support file-based storage and offline playback workflows in addition to streaming, by encapsulating the encoded components in a single container file that can be stored, transferred, or accessed at a later time.

In a particular embodiment, the content protection data 164 is included in a header of the encoded output data 162, metadata of the encoded output data 162, or a combination thereof. The segmentation data may include or correspond to a segmentation frame that is encoded by the encoder 128 as a no display frame (e.g., using a no display supplemental enhancement information (SEI) message). The encrypted ROI content 148 may be encoded by the encoder 128 as a no display frame (e.g., using a no display supplemental enhancement information (SEI) message). The encryption indicator 165 may indicate that the encrypted ROI content 148 is included in the bitstream, an encryption standard used by the encryptor 124, or both. The encryption indicator 165 may be included in the header or included in metadata associated with the encrypted ROI content 148 (or an encoded version of the encrypted ROI content 148).

In some embodiments, the key 137, or an encrypted version of the key 137 (encrypted based on a public key), may be included in or indicated by the encryption indicator 165, or included in metadata associated with the encrypted ROI content 148 (or an encoded version of the encrypted ROI content 148).

During operation of the system 100, the processor 108 receives media content, such as the image data 140. Additionally, or alternatively, the media content may include audio data. The media content, such as image data, audio data, or a combination thereof, may be received from a source device (e.g., a microphone or a camera) or from the memory 106. The image data 140 may include an image frame, such as the input image frame 142. In some embodiments, the image data 140 includes video data, such as a series of image frames including the input image frame 142. The processor 108 provides the input image frame 142 to the media generator 120 (e.g., the ROI identifier 121).

The ROI identifier 121 is configured to detect an instance of the object class 107 included in the input image frame 142 and identify an ROI associated with the detected instance of the object class 107—e.g., a portion of the input image frame 142 that includes the detected instance of the object class 107. As used herein, a portion of media data may refer to a region of interest identified via detection or segmentation of an object instance in the media. Based on the ROI, the ROI masker 122 masks the ROI (e.g., the portion of the input image frame 142) to generate the masked image frame 144. Additionally, based on the ROI, the ROI generator 123 generates the ROI content 146, which is encrypted by the encryptor 124 to generate the encrypted ROI content 148.

The combiner 126 combines the masked image frame 144 and the encrypted ROI content 148 to generate the combined output data 160. For example, the combiner 126 may concatenate the masked image frame 144 and the encrypted ROI content 148, or may modify the masked image frame 144 such that a masked portion of the masked image frame 144 includes the encrypted ROI content 148. Although the media generator 120 is described as including the combiner 126, in other implementations, the media generator 120 may not include the combiner 126 and the masked image frame 144 and the encrypted ROI content 148 may be provided to the encoder 128.

The encoder 128 generates output media data (e.g., the encoded output data 162) that includes or indicates the masked image frame 144, the encrypted ROI content 148, and the encryption indicator 165 that indicates the output media data includes the encrypted ROI content 148. In some embodiments, the encoded output data 162 includes the content protection data 164 that includes the encryption indicator 165. Additionally, or alternatively, the encoded output data 162 (e.g., the content protection data 164) includes a non-display indicator associated with the encrypted media data.

The processor 108 may provide the encoded output data 162 to the memory 106 for storage. Additionally, or alternatively, the processor 108 may send the encoded output data 162 to a decode device of the device 102 or to another device (e.g., a remote device) that includes a decoder.

In some embodiments, the media generator 120 (e.g., the ROI identifier 121) is configured to generate, based on the input image frame 142 and detection of an instance of the object class 107 in the input image frame 142, segmentation data. Generation of the segmentation data (e.g., a segmentation frame) is described further herein at least with reference to FIG. 5.

In some embodiments, a device (e.g., the device 102) includes one or more processors are configured to obtain input media data that includes an instance of an object class (e.g., the image data 140 or the input image frame 142), and encrypt a portion of the input media data that includes the instance of the object class to generate encrypted media data (e.g., encrypted ROI content 148). The one or more processors are also configured to mask the portion of the input media data to generate a masked version (e.g., the masked image frame 144) of the input media data, and generate output media data (e.g., the encoded output data 162). The output media data includes the masked version of the input media data, the encrypted media data, and content protection data (e.g., the content protection data 164). The content protection data includes an encryption indicator (e.g., the encryption indicator 165) that indicates the output media data includes the encrypted media data.

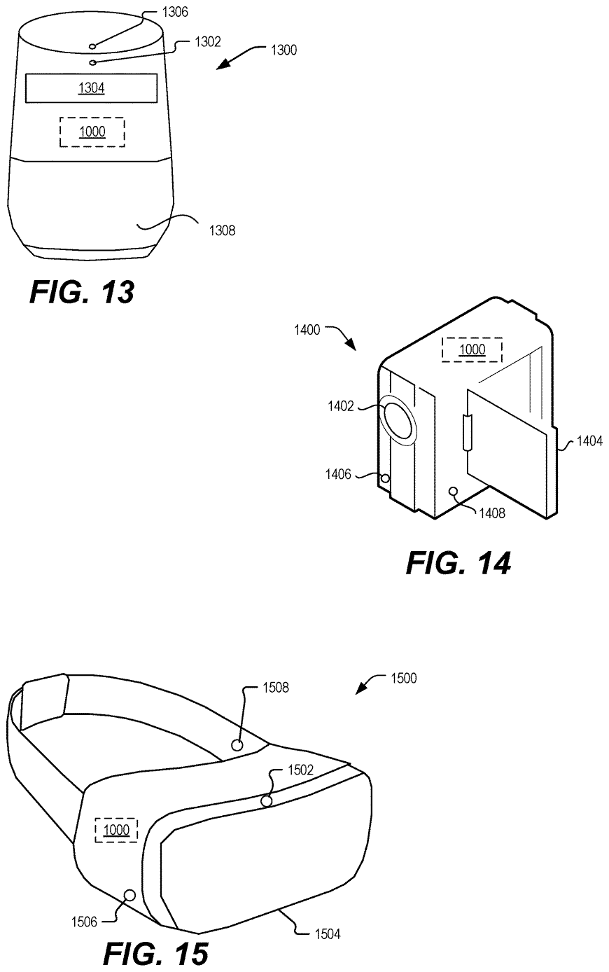

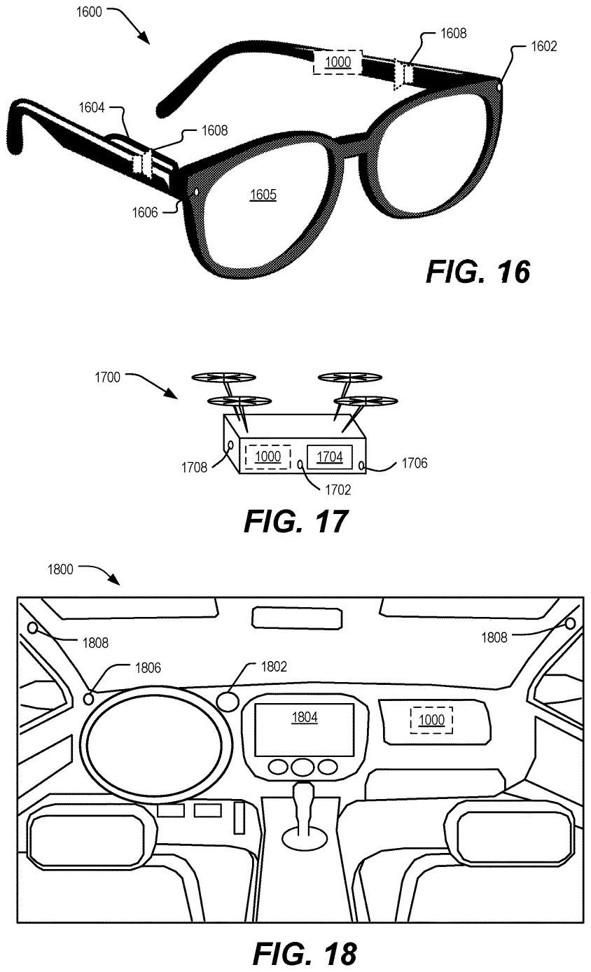

In some examples, the device 102 corresponds to or is included in one of various types of devices, such that the processor 108 can be integrated in multiple types of devices. In an illustrative example, the processor 108 is integrated in a wearable electronic device as depicted in FIG. 12, a virtual reality, mixed reality, or augmented reality headset as depicted in FIG. 15, a mixed reality or augmented reality glasses device as described with reference to FIG. 16, or another wearable device. In another illustrative example, the processor 108 is integrated in a mobile device (a mobile phone or a tablet computer device) as depicted in FIG. 11, a voice-controlled speaker system as depicted in FIG. 13, a camera as depicted in FIG. 14, a vehicle as depicted in FIG. 17 or FIG. 18, a computer (e.g., a laptop computer) or a server, or another system or device.

As described with reference to FIG. 1, the present disclosure provides techniques for supporting identification and encryption of media content. For example, one technical advantage of implementing the device 102 as described above is that privacy control and content management provided by identification of the ROI (associated with the object class 107) of the input image frame 142, and encryption of at least the portion the input image frame 142 based on the ROI. To further illustrate the technical advantage, sensitive, private, or confidential content to be protected in the input image frame 142 is masked based on the ROI to generate the masked image frame 144, which can be displayed by one or more device or users that do not have authorization or access to the sensitive content (e.g., the encrypted ROI content). In some aspects, the encoded output data 162 includes the encryption indicator 165 that indicates that encrypted ROI content 148 may be recovered and combined with the masked image frame 144 to generate (e.g., recreate) the original content (e.g., the input image frame 142) by one or more devices or users that have authorization or access to the sensitive content and that have the key 137. In some embodiments, the operations described with reference to the system 100 may be applied to provide automatic sensitive content (partial video) encryption while the video is captured for the first time. The partial video encryption, through use of the encryption indicator 165, can allow for both authorized and non-authorized access of encrypted content using the same encoded output data 162 (e.g., the same encrypted bitstream).

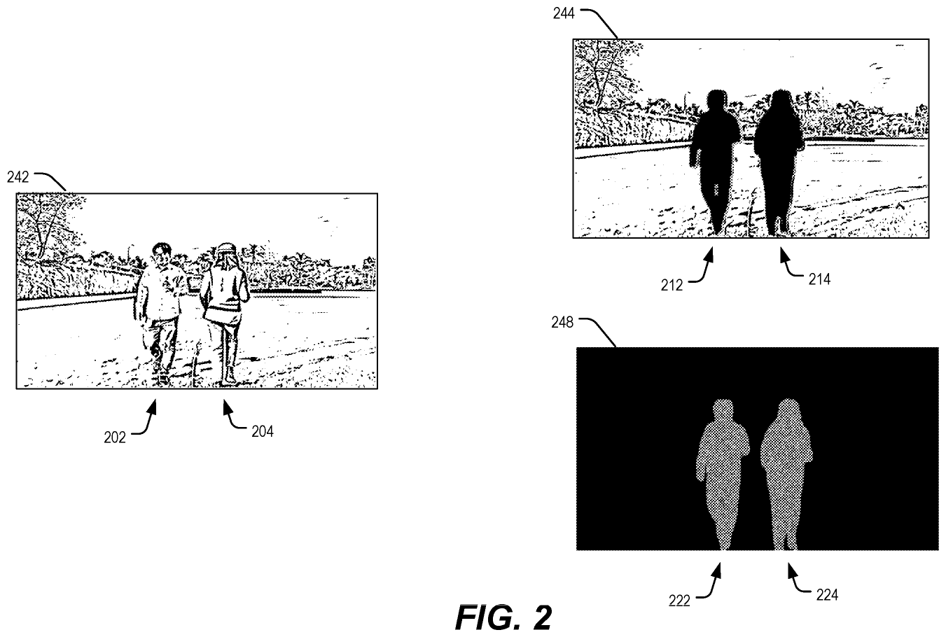

FIG. 2 is a diagram of examples of image frames to illustrate operations associated with the system of FIG. 1, in accordance with one or more aspects of the present disclosure. For example, the operations may be associated with or correspond to operations of the processor 108 (e.g., the media generator 120) as described with reference to FIG. 1.

The examples of the image frames include an input image frame 242, a masked image frame 244, and a frame including encrypted content (e.g., an encrypted ROI frame). The input image frame, the masked image frame 244, and the encrypted ROI frame 248 (including the encrypted content) may include or correspond to the input image frame 142, the masked image frame 144, and the encrypted ROI content 148, respectively.

The image frames of FIG. 2 depict operations associated with FIG. 1 in which the object class 107 is or includes a person or people. For example, the ROI identifier 121 (e.g., an object class detector) may identify instances of the object class 107 present in the input image frame 242. It is noted that the object class 107 being a person or people is for illustration and the object class 107 may be or include a different object class other than a person or people. The ROI masker 122 may generate the masked image frame 244, which is a masked version of the input image frame 242 in which at least one or more objects that correspond to instances of the object class 107 detected by the ROI identifier 121 are masked. The ROI generator 123 may generate the ROI content that corresponds to or is based on the detected one or more objects detected by the ROI identifier 121. The encryptor 124 may encrypt the ROI content 146 to generate the encrypted ROI frame 248.

The input image frame 242 includes an image of a scene. The scene includes a first object 202 and a second object 204. Each of the first object 202 and the second object 204 is a respective person. The first object 202 and the second object 204 include or correspond to instances of a detected object class 107 (e.g., people) detected by the ROI identifier 121.

The masked image frame 244 includes a mask having a first portion 212 and a second portion 214. The first portion 212 of the mask corresponds to the first object 202 in the input image frame 242, and the second portion 214 corresponds to the second object 204 in the input image frame 242.

The encrypted ROI frame 248 includes first encrypted content 222 and second encrypted content 224. The first encrypted content 222 corresponds to the first object 202 and/or the first portion 212 of the mask. The second encrypted content corresponds to the second object 204 and/or the second portion 214 of the mask.

FIG. 3 is a diagram of an example of the encoded output data 162 to illustrate operations associated with the system of FIG. 1, in accordance with one or more aspects of the present disclosure, and is designated 300. As described above with reference to FIG. 1, the encoded output data 162 may be generated by the encoder 128. For example, the encoder 128 may generate the encoded output data 162 based on the image data 140, the input image frame 142, the masked image frame 144, the encrypted ROI content 148, the combined output data 160, an ROI segmentation frame (as described further herein at least with reference to FIG. 5), one or more encoder parameters (e.g., one or more encoding parameters), or a combination thereof.

The encoded output data 162 of FIG. 3 includes the content protection data 164 and encoded data 410. The content protection data 164 is included in a header of the encoded output data 162, metadata of the encoded output data 162, or a combination thereof. As illustrated, the content protection data 164 includes the encryption indicator 165. Additionally, or alternatively, the content protection data 164 may include one or more encryption parameters, one or more indicators or data, or a combination thereof. The one or more encryption parameters may include or indicate an encryption type, a maximum block size, an alphabet size, one or more formatting details, a number of object classes, or a combination thereof. Examples of the one or more indicators or the data are described further herein at least with reference to FIGS. 4A and 4B.

The encoded data 410 may include or correspond to the masked image frame 144, the encrypted ROI content 148, the combined output data 160, or a combination thereof. In some embodiments, the encoded data 410 includes an encoded version of the combined output data 160 encoded by the encoder 128. In the illustrated embodiment, the encoded data 410 includes an encoded masked image frame 414 and encoded encrypted ROI content 418. The encoded masked image frame 414 may include or correspond to an encoded version of the masked image frame 144 encoded by the encoder 128. The encoded encrypted ROI content 418 may include or correspond to an encoded version of the encrypted ROI content 148 encoded by the encoder 128. The encoded masked image frame 414 may also be referred to herein as an encoded masked image frame corresponding to the masked image frame 144. The encoded encrypted ROI content 418 may also be referred to herein as an encoded encrypted ROI frame corresponding to the encrypted ROI content 148.

Although the encoded output data 162 of FIG. 3 is described as including the encoded masked image frame 414 and the encoded encrypted ROI content 418, in other examples, the encoded output data 162 may not include one of the encoded masked image frame 414 or the encoded encrypted ROI content 418. To illustrate, the encoded output data 162 may not include the encoded encrypted ROI content 418. In such examples, the encryption indicator 165 (e.g., a value of the encryption indicator 165) may indicate that encoded data 410 does not include encrypted content (e.g., the encoded encrypted ROI content 418).

FIG. 4A is a diagram of examples of the encoded output data 162 to illustrate operations associated with the system of FIG. 1, in accordance with one or more aspects of the present disclosure. As described above with reference to FIG. 1, the encoded output data 162 may be generated by the encoder 128. For example, the encoder 128 may generate the encoded output data 162 based on the image data 140, the input image frame 142, the masked image frame 144, the encrypted ROI content 148, the combined output data 160, an ROI segmentation frame (as described further herein at least with reference to FIG. 5), one or more encoder parameters (e.g., one or more encoding parameters), or a combination thereof.

Each of the examples of the encoded output data 162 of FIG. 4A include the content protection data 164 and encoded data 410. The content protection data 164 of each of the examples of FIG. 4A includes at least the encryption indicator 165. The encoded data 410 may include or correspond to the masked image frame 144, the encrypted ROI content 148, the combined output data 160, or a combination thereof. In some embodiments, the encoded data 410 includes an encoded version of the combined output data 160 encoded by the encoder 128.

The encoded data 410 of each of the examples of FIG. 4A includes an encoded masked image frame 414 and encoded encrypted ROI content 418. The encoded masked image frame 414 may include or correspond to an encoded version of the masked image frame 144 encoded by the encoder 128. The encrypted ROI content 418 may include or correspond to an encoded version of the encrypted ROI content 148 encoded by the encoder 128.

A first example of the encoded output data 162 is designated 400. The encoded output data 162 of the first example 400 includes an identity indicator 407. For example, the content protection data 164 may include the identity indicator 407. The identity indicator 407 may include or indicate a device identification (ID) of a device (e.g., that generated the encoded output data 162), a user ID of a user of the device, or a combination thereof. For example, the device may include or correspond to the device 102.

A second example of the encoded output data 162 is designated 430. The encoded output data 162 of the second example 430 includes a non-display indicator 431 and, optionally (as indicated by dashed lines), an encoded segmentation frame 455 (e.g., segmentation data). The non-display indicator 431 may indicate to a decoder to decode particular data (e.g., a particular frame), but not display the decoded data. For example, the non-display indicator 431 may include a non-display flag or a no display message (e.g., a no display supplemental enhancement information (SEI) message). The non-display indicator 431 may indicate or correspond to the encrypted ROI content 148 (e.g., a frame that includes the encrypted ROI content 148), a segmentation frame, the encoded encrypted ROI content 418, or the encoded segmentation frame 455.

The encoded segmentation frame 455 may include or correspond a segmentation frame encoded by the encoder 128. The segmentation frame may include a segmented version of the input image frame 142 that is segmented based on or in association with a detected object class included in the input image frame 142. For example, the segmentation frame 455 may include or correspond to an ROI segmentation frame 555 as described with reference to FIG. 5.

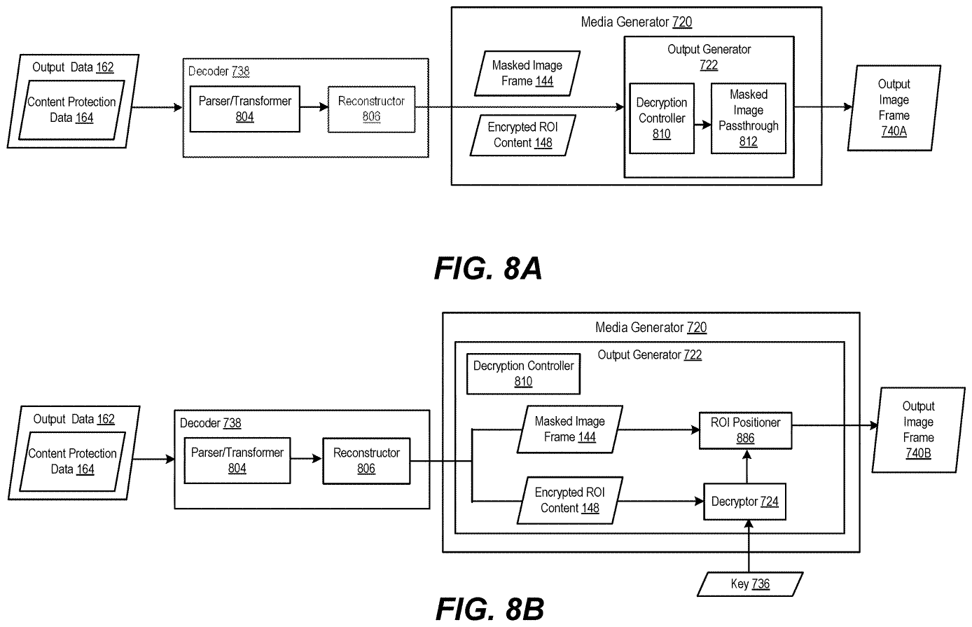

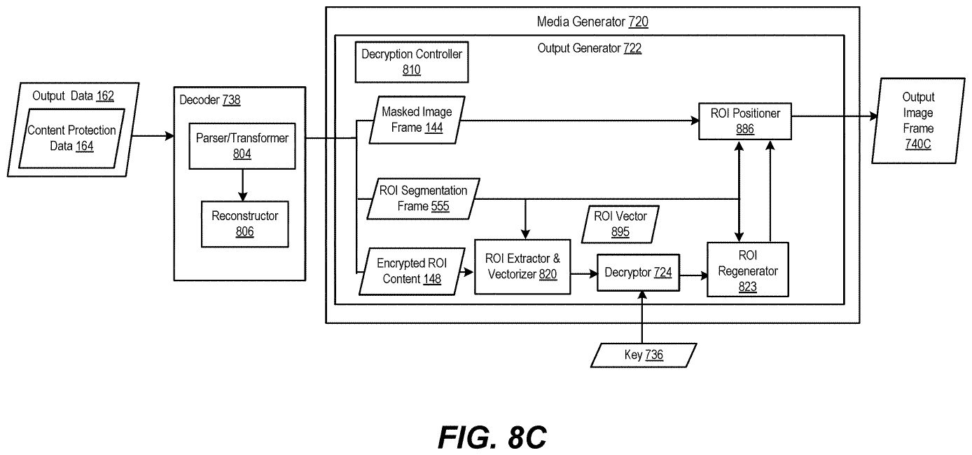

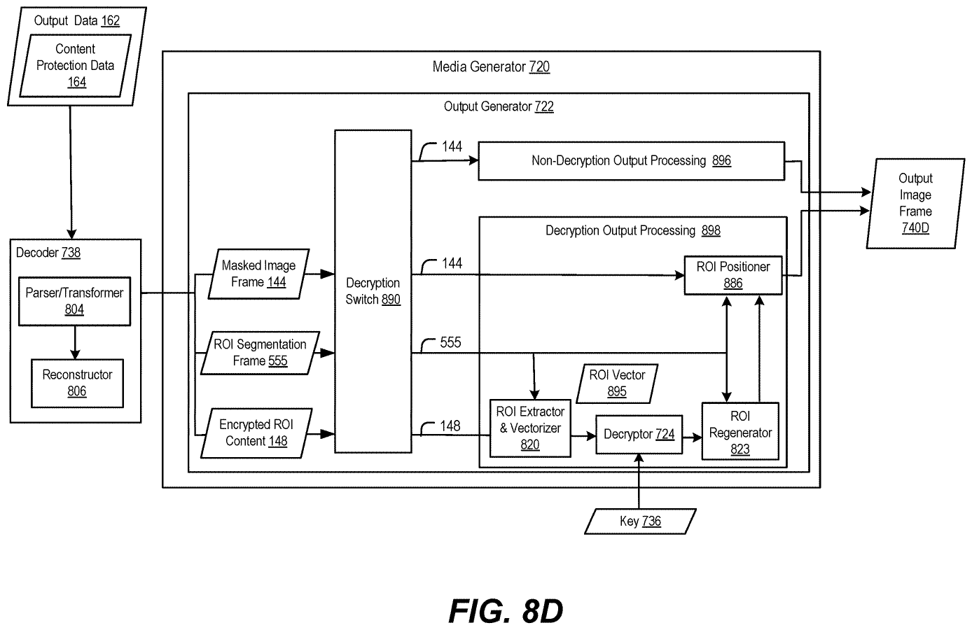

A third example of the encoded output data 162 is designated 450. The encoded output data 162 of the third example 450 optionally (as indicated by dashed lines) includes position data 452 or an encoded segmentation frame 455 (e.g., segmentation data). For example, the encoded output data 162 includes one of the position data 452 or an encoded segmentation frame 455. Each of the position data 452 and the encoded segmentation frame 455 may enable decrypted ROI content (based on the encoded encrypted ROI content 418) to be combined with a decoded masked image frame (based on the encoded masked image frame 414). For example, the position data 452 may indicate a position (e.g., a pixel location) associated with the decoded masked image frame (based on the encoded masked image frame 414) where the decrypted ROI content (based on the encoded encrypted ROI content 418) is to be positioned. As explained above, the encoded segmentation frame 455 may include or correspond to a segmentation frame that includes a segmented version of the input image frame 142 that is segmented based on or in association with a detected object class included in the input image frame 142. The encoded segmentation frame 455 may be decoded to obtain the segmentation frame which may be used to combine decrypted ROI content (based on the encoded encrypted ROI content 418) with a decoded masked image frame (based on the encoded masked image frame 414), as described further herein at least with reference to FIG. 8C.

A fourth example of the encoded output data 162 is designated 460. The encoded output data 162 of the fourth example 460 includes an object class indicator 461. The object class indicator 461 may be associated with an object class (e.g., the object class 107) detected in the input image frame 142 and for which the encrypted ROI content 148 was generated (and thereby the encoded encrypted ROI content 418). For example, the object class indicator 461 may indicate one or more object classes, a number of detected objects, a number object classes (detected in the input image frame 142), or a combination thereof.

Although each of the examples of FIG. 4A are described as including the encryption indicator 165, in other examples, one or more of the examples of FIG. 4A may not include the encryption indicator 165. Additionally, or alternatively, although the examples of FIG. 4A are described as separate examples, it is noted that the encoded output data 162 may include the identity indicator 407, the non-display indicator 431, the position data 452, the encoded segmentation frame 455, the object class indicator 461, or a combination thereof.

FIG. 4B is a diagram of an example of a bitstream 499 of encoded output data to illustrate operations associated with the system of FIG. 1, in accordance with one or more aspects of the present disclosure. In an illustrative example, the bitstream 499 corresponds to the encoded output data 162.

The bitstream 499 includes sequence data 470 and a sequence of encoded frames that includes data corresponding to the frames. The sequence data 470 includes the encryption indicator 165 and encryption parameters 472. For example, the encryption indicator 165 can correspond to a 1-bit Boolean value, and a non-zero value (e.g., TRUE) can indicate that at least one frame of the sequence includes encrypted data, and a zero value (e.g., FALSE) can indicate that the sequence includes no encrypted data. In another example, a non-zero value (e.g., TRUE) of the encryption indicator 165 can indicate that encryption was enabled during processing of the frames of the sequence and therefore there is a possibility that the sequence includes encrypted data, and a zero value (e.g., FALSE) can indicate that encryption was not enabled during processing of the frames and therefore the sequence includes no encrypted data.

The encryption parameters 472 can include, for one or more encryption algorithms used to encrypt data in the sequence, data identifying the particular encryption algorithm, a number of parameters for the particular algorithm, an encryption mode, a total parameter size, values of the parameters for the particular algorithm, or a combination thereof. In some embodiments, the encryption parameters include cipher text corresponding to an encrypted secret key for decrypting the encrypted ROI content. For example, the encrypted secret key may be encrypted using a public key of an authorized recipient. Examples of possible algorithm parameters include alphabet size, max block size, input data bit-width, public key certificate (e.g., digital certificate or identity certificate), certificate authority, digital signature, one or more other parameters, or a combination thereof. An illustrative, non-limiting description of data fields that may be included in the sequence data 470 is provided in Table 1.

TABLE 1

| Field Name | Size in bits |
|---|---|
| encryption_indicator | 1 |
| if (encryption_indicator) { | 3 . . . 8 |
| encryption_algorithm_ID | 3 . . . 8 |
| num_encryption_algorithm_parameters | 3 . . . 8 |
| encryption_mode | 16 |
| total_size_parameters | algorithm specific/defined |
| for(i=0, i < num_encryption_algorithm_parameters, i++) | offline |
| encryption_parameter[i] | |
| } | |

In the example pseudocode in Table 1, if the encryption_indicator is TRUE, then fields are defined for an encryption_algorithm_ID, a number of encryption algorithm parameters (num_encryption_algorithm_parameters), an encryption_mode, a total size of the parameters (total_size_parameters), and an array of the algorithm parameters (encryption_parameter [i]). This information can be defined per sequence to indicate that encrypted information exists in the bitstream, and indicates which encryption algorithm is used and the parameters associated with it. Examples of encryption algorithms include FF1: Format-preserving Feistel-based Encryption Mode (ANSI X9 as X9.119 and X9.124); FF3-1: DRAFT SP 800-38G Rev 2; and FF2: The FFX Mode of Operation for Preserving Encryption, as illustrative, non-limiting examples.

The bitstream 499 also includes an encoded masked image frame 474, an encoded segmentation frame 482 associated with the encoded masked image frame 474, and an encoded encrypted ROI frame 492 associated with the encoded masked image frame 474. The encoded masked image frame 474 includes a header 476 and encoded pixel data 480. The header 476 includes metadata associated with a frame of the input image data 140 (e.g., the input image frame 142), including a display order frame ID 478, such as a display order frame ID that indicates a display order of the encoded masked image frame 474 in the sequence. In an illustrative embodiment, the encoded masked image frame 474 corresponds to the encoded masked image frame 414.

The encoded segmentation frame 482 includes a header 484 and encoded pixel data 490. The header 484 includes metadata for a ROI segmentation frame (e.g., the ROI segmentation frame 555 of FIG. 5) corresponding to the encoded masked image frame 474. As illustrated, the header 484 includes a ROI segmentation frame flag 485 that identifies the frame as an encoded segmentation frame, a no display SEI 486 that indicates that the frame is not to be displayed, and a frame ID 487 that indicates or corresponds to the display order frame ID 478 to associate the encoded segmentation frame 482 with the encoded masked image frame 474. The header 484 also includes ROI ID data 488 associated with ROIs in the frame, such as a number of ROIs in the frame and identification of each of the ROIs in the frame. In an illustrative embodiment, the encoded segmentation frame 482 corresponds to the encoded segmentation frame 455.

An illustrative, non-limiting description of data fields that may be included in the header 484 is provided in Table 2.

TABLE 2

| | Size |
|---|---|
| Field Name | in bits |
| frame_with_ROI_segmentations | 1 |
| display_order_frame_ID | 16 |
| num_ROIs | 8 |
| for(i=0, i < num_ROIs, i++) | |
| ROI_global_ID[i] | 16 |

In the example pseudocode in Table 2, a frame_with_ROI_segmentations field corresponds to the ROI segmentation frame flag 485, and a display_order_frame_ID field corresponds to the frame ID 487. A num_of ROIs field indicates how many ROIs are in the frame, and a ROI global_ID array field indicates, for each of the ROIs in the frame, a global ROI identifier (ROI global_ID) of that ROI. In an illustrative example, the num_of_ROIs and ROI_global_ID fields correspond to the ROI ID data 488. For example, a respective unique “global” identifier may be assigned to each ROI that is identified in the image data 140, and the particular ROIs in the encoded segmentation frame 482 are identified in the ROI_global_ID array field by their global identifiers. In a particular example, the order of the ROIs in the ROI global_ID array field is determined based on the order that each of the ROIs is encountered by a raster scan (e.g., left to right on each row, from top to bottom). To illustrate, the ROIs are ordered based on the row position of their upper-most pixel(s) from top to bottom and, if multiple ROIs have their upper-most pixel on the same row, from left to right within the row.

The encoded encrypted ROI frame 492 includes a header 494 and encoded encrypted pixel data 498. The header 494 includes metadata for an encrypted ROI segmentation frame (e.g., the encrypted ROI frame 248 or the encrypted ROI frame 536 of FIG. 5) corresponding to the encoded masked image frame 474. As illustrated, the header 494 includes an encrypted ROI segmentation frame flag 495 that identifies the frame as an encoded encrypted ROI frame, the no display SEI 486 that indicates that the frame is not to be displayed, and the frame ID 487 that indicates or corresponds to the display order frame ID 478 to associate the encoded encrypted ROI frame 492 with the encoded masked image frame 474. The header 494 also includes encryption parameters 496 associated with the encrypted ROI(s) in the frame. In an illustrative embodiment, the encoded encrypted ROI frame 492 corresponds to or is included in the encoded encrypted ROI content 418.

An illustrative, non-limiting description of data fields that may be included in the header 494 is provided in Table 3.

TABLE 3

| Field Name | Size in bits |
|---|---|
| frame_encrypted_ROI_segmentations | 1 |
| Display_order_frame_ID | 16 |
| total_size_parameters | 16 |
| for(i=0, i < Num_ROIs, i++) | |
| ROI_encryption_parameters[i] | Encryption_algorithm_specific |

In the example pseudocode in Table 3, the fields include a frame_encrypted_ROI_segmentations field that corresponds to the encrypted ROI segmentation frame flag 495, a display_order_frame_ID field that corresponds to the frame ID 487, and a total_size_parameters field that indicates a total size of an array of ROI_encryption_parameters for each of the encrypted ROIs in the frame. To illustrate, the number of ROIs in the frame (Num_ROIs) may be obtained from the header 484 of the encoded segmentation frame 482, and the encryption parameters for each of the ROIs may be encryption-algorithm-specific optional parameters and can include, for example, cipher text containing the encrypted secret key using the public key of the capture device, the ROI class, or both.

Although the encoded output data 162 of FIG. 3 and FIG. 4A and the bitstream 499 of FIG. 4B are described above in the context of a bitstream-based arrangement, in some embodiments the components of the encoded output data 162-including, for example, the encoded masked image frame 414 (e.g., the encoded masked image frame 474), the encoded encrypted ROI content 418 (e.g., the encoded encrypted ROI frame 492), the encoded segmentation frame 455 (e.g., the encoded segmentation frame 482), the encryption indicator 165, and the content protection data 164—are instead organized within a media container as described herein with reference to FIG. 1. For example, the encoded masked image frame 414 may be included in a first track of the media container, the encoded encrypted ROI content 418 may be included in a second track of the media container, and the encoded segmentation frame 455, the encryption indicator 165, and the content protection data 164 may be included in a metadata field, a supplemental track, an embedded data field, or a combination thereof, of the media container.

In some such embodiments, frame association data analogous to the display order frame ID 478 and the frame ID 487 (which, in the bitstream 499, are included in the headers 476, and 484 and 494, respectively) may be carried as container-level metadata to associate frames within the media container. Additionally, or alternatively, an indication that a frame or track of the media container is not to be displayed by a standard media player (analogous to the no-display SEI 486 in the bitstream 499) may be included as container-level metadata associated with the encoded encrypted ROI content 418, the encoded segmentation frame 455, or both.

FIG. 5 is a diagram of an illustrative example of the processor 108 of the system 100 of FIG. 1, in accordance with one or more aspects of the present disclosure. The processor 108 of FIG. 5 is configured to generate an ROI segmentation frame 555, as described herein.

The processor 108 includes the media generator 120 and the encoder 128. The media generator 120 includes the ROI identifier 121, the ROI masker 122, the ROI generator 123, the encryptor 124, an encrypted ROI positioner 534, and the combiner 126. The ROI identifier 121 includes an ROI detector 510 and an ROI segmentor 512.

The ROI detector 510 is configured to detect an instance of the object class 107 included in the input image frame 142, and identify an ROI associated with the detected object class. To illustrate, the ROI identifier 121 may receive the content protection indicator 135 that includes or indicates the object class 107. In some examples, the content protection indicator 135 includes or indicates a model to be used by the ROI identifier 121 (e.g., the ROI detector 510) to detect instances of the object class 107 included in the input image frame 142.

The ROI segmentor 512 is configured to, based on the detected ROI by the ROI detector 510, generate the ROI segmentation frame 555. For example, the ROI segmentation frame 555 may indicate the ROI (identified by the ROI detector 510) in a frame.

The ROI masker 122 is configured to receive a mask indicator 504. In some embodiments, the mask indicator 504 is received from the protection controller 110. For example, the content protection indicator 135 may include or indicate the mask indicator 504. The mask indicator 504 may include or indicate a mask technique or a mask type to be used by the ROI masker 122. The ROI masker 122 may generate the masked image frame 144 based on the mask indicator 504, the input image frame 142, and the ROI segmentation frame 555. For example, the ROI masker 122 may apply a mask (based on the mask indicator 504) to the input image frame 142 at a location/position based on the ROI segmentation frame 555 to generate the masked image frame 144.

The ROI generator 123 includes an ROI extractor 520 and an ROI vectorizer 522. The ROI extractor 520 is configured to extract an ROI from the input image frame 142. The extracted ROI may be a two-dimensional (2D) data structure, such as a 2D array that is at least partially populated with pixel values of pixels that are indicated, by use of the ROI segmentation frame 555, to be within the ROI. In a particular embodiment, the ROI extractor 520 applies the ROI segmentation frame 555 as a segmentation mask to the input image frame 142 to extract the ROI.

The ROI vectorizer 522 is configured to generate one or more ROI vectors 524 based on the extracted ROI. The ROI vector 524 may be one-dimensional (1D). In some embodiments, to generate the ROI vector 524, the ROI vectorizer 522 is configured to perform a raster scan on the extracted ROI. For pixel formats with no chroma-subsampling, such as YUV444 or RGB, each channel may be added one after the other to generate the ROI vector 524. Alternatively, the ROI vectorizer 522 may generate the ROI vector 524 one channel at a time. For other pixel formats with chroma-subsampling, such as YUV420, the segmentation mask may be downscaled using a chroma sub-sampling ratio and the downscaled data may be vectorized accordingly. It is noted that the ROI vectorizer 522 may generate a respective ROI vector 524 for each object of the object class 107 detected in the input image frame 142.

The encryptor 124 is configured to receive the ROI vector 524 and encrypt the ROI vector 524 to generate encrypted ROI content 532. For example, the encryptor 124 may receive the ROI vector 524 from the ROI generator 123 and encode, based on the key 137, the ROI vector 524. In some embodiments, the encryptor 124 uses a format preserving encryption (input and output have the same size) to generate the encrypted ROI content 532 based on the ROI content of the ROI vector 524.

The encrypted ROI positioner 534 is configured to receive the encrypted ROI content 532 and generate the encrypted ROI frame 536. For example, the encrypted ROI positioner 534 may receive the ROI segmentation frame 555 and may position the encrypted ROI content 532 in the ROI segmentation frame 555 to generate the encrypted ROI frame 536. To illustrate, the encrypted ROI positioner 534 may position the encrypted ROI content 532 in the ROI segmentation frame 555 at a location/position that is associated with the ROI identified by the ROI identifier 121. In some embodiments, the encrypted ROI positioner 534 receives the encrypted ROI content 532 (e.g., a 1D vector) and converts the 1D vector back into a 2D data structure. The encrypted ROI positioner 534 may include the encrypted ROI using the same exact location as the original data using the initial segmentation.

The combiner 126 is configured to combine the masked image frame 144, the ROI segmentation frame 555, the encrypted ROI frame 536, one or more encoder parameters, or a combination thereof, to generate the combined output data 160. In some embodiments, to generate the combined output data 160, the combiner 126 is configured to concatenate the masked image frame 144, the ROI segmentation frame 555, and the encrypted ROI frame 536 to generate the combined output data 160.

The encoder 128 is configured to receive the combined output data 160 and generate encoded output data 162. In some embodiments, the encoder 128 may encode the combined output data 160 based on the content protection indicator 135, one or more encoder parameters received from the protection controller 110 and/or the media generator 120, or a combination thereof. Additionally, or alternatively, the encoder 128 may include additional data to facilitate decode processing of the encoded output data 162 by a decoder.

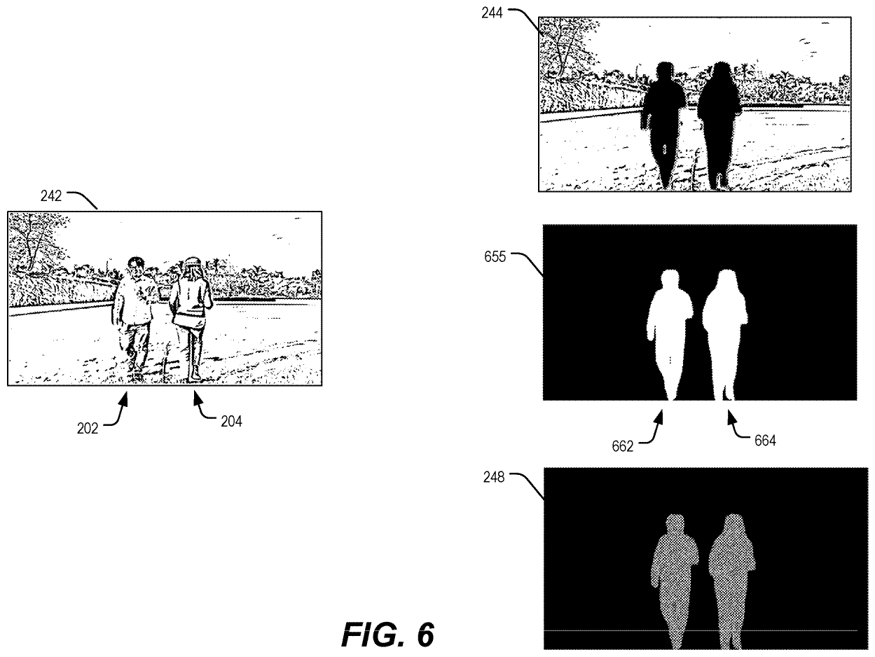

FIG. 6 is a diagram of examples of image frames to illustrate operations associated with the system of FIG. 1, in accordance with one or more aspects of the present disclosure. For example, the operations may be associated with or correspond to operations of the processor 108 (e.g., the media generator 120) as described with reference to FIG. 1 or FIG. 5.

The examples of the image frames include an input image frame 242, a masked image frame 244, a segmentation frame 655, and a frame including encrypted content (e.g., an encrypted ROI frame 248). The input image frame 242 and the masked image frame 244 may include or correspond to the input image frame 142 and the masked image frame 144, respectively. The encrypted ROI frame 248 (including the encrypted content) may include or correspond to the encrypted ROI content 148 or the encrypted ROI frame 536. The segmentation frame 655 may include or correspond to the encoded segmentation frame 455 or the ROI segmentation frame 555. For purposes of illustration, the segmentation frame 655 includes pixels having two values: white (e.g., 1) for pixels in an identified ROI, and black (e.g., 0) for pixels not in an identified ROI. As illustrated, the segmentation frame 655 indicates a first ROI 662 corresponding to the first object 202 (e.g., a first person) and a second ROI 664 corresponding to the second object 204 (e.g., a second person) of the input image frame 242.

The image frames of FIG. 6 are described herein with reference to operations associated with of FIG. 5 in which the content protection indicator 135 (that indicates the object class 107) indicates a person or people. For example, the ROI identifier 121 (e.g., the ROI detector 510) may identify objects that are instances of the object class 107 indicated by the content protection indicator 135 as present in the input image frame 242. It is noted that the object class 107 being a person or people is for illustration and the object class 107 may be or include a different object class other than a person or people. The ROI identifier 121 (e.g., the ROI segmentor 512) may generate the ROI segmentation frame 555 (e.g., the segmentation frame 655) based on the object (e.g., the ROI) detected by the ROI detector 510.

The ROI masker 122 may generate, based on the input image frame 142 and the ROI segmentation frame 555, the masked image frame 244 which is a masked version of the input image frame 242 in which at least one or more objects (e.g., the objects 202, 204) detected by the ROI identifier 121 are masked. The ROI generator 123 may generate, based on the input image frame 142 and the ROI segmentation frame 555, the ROI vector 524 that is associated with content that corresponds to or is based on the detected one or more objects detected by the ROI identifier 121. The encryptor 124 may encrypt the ROI content 146 to generate the encrypted ROI content 532. The encrypted ROI positioner 534 may generate the encrypted ROI frame 248 based on the encrypted ROI content 532 and the ROI segmentation frame 555.

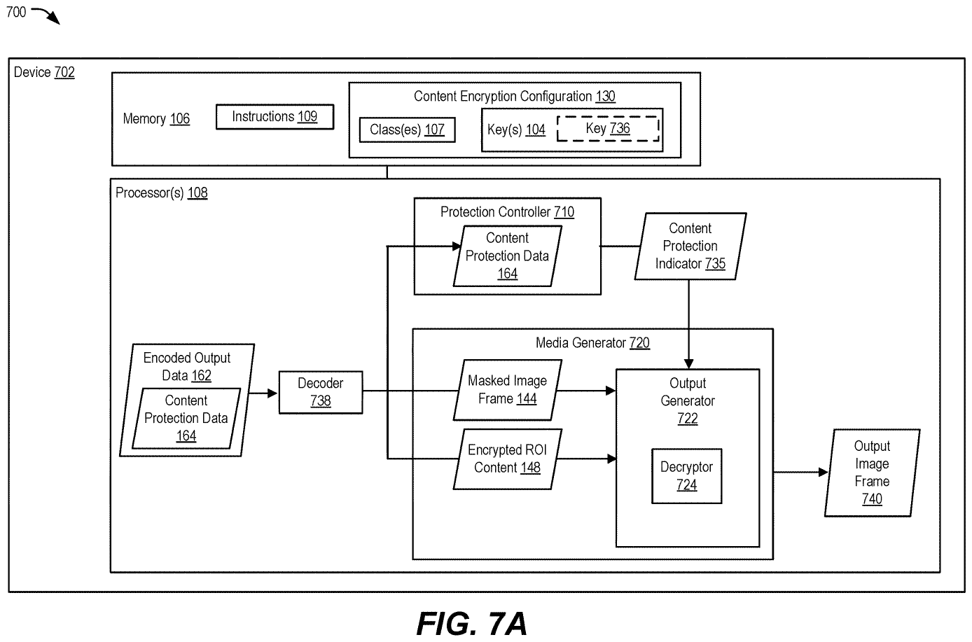

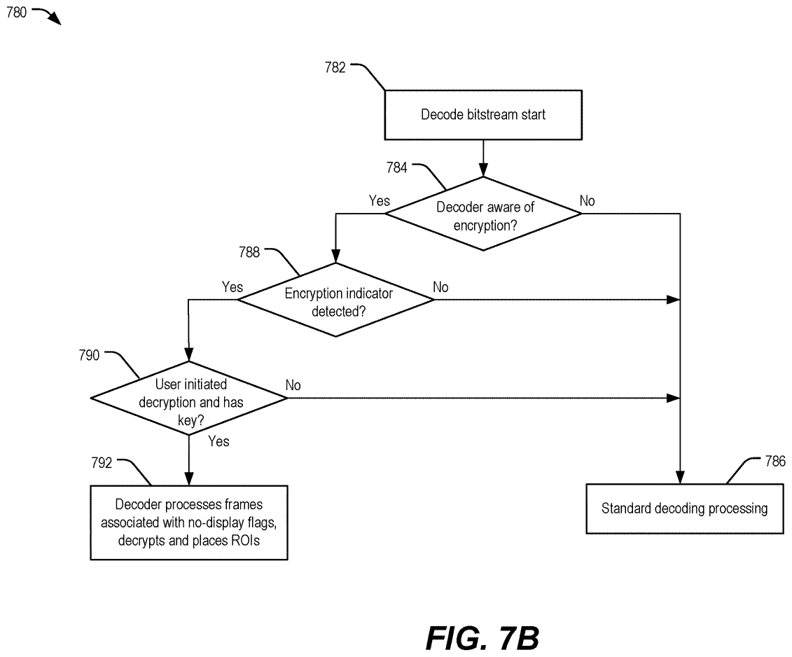

FIG. 7A is a block diagram of an example of a system 700 to decode media content, in accordance with one or more aspects of the present disclosure. The system 700 includes a device 702 that is configured to or is operable to identify an encryption indicator that indicates encrypted media content and decrypt the encrypted media content. The device 702 may include or correspond to the device 102.

The device 702 includes, or is coupled to, the memory 106 and the processor 108. The memory 106 may include one or more memory devices, such as a single memory or multiple different memory devices (of the same type or of different types).

The memory 106 is configured to store instructions 109 and a content encryption configuration 130. The instructions 109, when executed by the processor 108, cause the processor 108 to perform one or more operations as described herein. The content encryption configuration 130 may be associated with or indicate content (e.g., sensitive content) to be protected.

The content encryption configuration 130 includes the object class 107 and the key 104. The key 104 may include or correspond a respective object class 107. The key 104 may be configured to decrypt at least a portion of media content that includes or is associated with an instance of the object class 107, decrypt an encrypted key, or a combination thereof. For example, the key 104 may include a first key (e.g., a decryption key) configured to decrypt at least a portion of media content that includes or is associated with an instance of the object class 107, a second key (e.g., a public key) configured to encrypt information (such as the first key), a third key (e.g., a private key) configured to decrypt information encrypted using the second key, or a combination thereof.

In some examples, the memory 106 stores other information or data, such as media content. The media content can include or indicate audio content, video content, or a combination thereof. In some examples, the stored media content includes at least an encrypted portion.

The processor 108 includes a protection controller 710, a media generator 720, and a decoder 738. The protection controller 710 and the media generator 720 may include or correspond to the protection controller 110 and the media generator 120, respectively. Each of the protection controller 710, the media generator 720, and the decoder 738, or a portion thereof, may be implemented by the processor 108 executing instructions (e.g., software), dedicated hardware (e.g., circuitry), a combination thereof. It is noted that in some embodiments, two or more of the protection controller 710, the media generator 720, and the decoder 738 may be combined. For example, the media generator 720 may include the protection controller 710, the decoder 738, or both.

The decoder 738 is configured to receive the encoded output data 162 and decode the encoded output data 162 to obtain the combined output data 160 including the content protection data 164 (e.g., the encryption indicator 165), the masked image frame 144, and the encrypted ROI content 148. In some embodiments, the decoder 738 may decode the content protection data 164 to identify or determine one or more indicators, data, or a combination thereof, included in or indicated by the content protection data 164. For example, the content protection data 164 may include or indicate an object class indicator (that indicates the object class, a number of object classes, or a combination thereof), a device ID, a user ID of a user of the device, an encryption type indicator, one or more encryption parameters, or a combination thereof.

The protection controller 710 is configured to receive at least a portion of the content protection data 164. The protection controller 710 may determine, based on the content protection data 164, a content protection indicator 735. The content protection indicator 735 may include or indicate the encryption indicator 165 or a value thereof, the key 736, one or more encryption/decryption parameters, an object class 107, or a combination thereof. For example, the protection controller 710 may determine the object class 107 based on the object class indicator 461 included in or indicated by the content protection data 164. As another example, the protection controller 710 may determine the encryption/decryption parameters based on the encryption indicator 165, the identity indicator 407, the object class indicator 461, or a combination thereof, included in or indicated by the content protection data 164. In some embodiments, the content protection indicator 735 may indicate the content encryption configuration 130 (e.g., an encryption requirement) that includes the object class 107, the key 104 (e.g., an encryption key, a public key, or a private key), or a combination thereof, to be applied by the media generator 720 (e.g., the output generator 722) to identify or detect, and decrypt the encrypted ROI content 148. In some embodiments, the content protection indicator 735 may indicate a list of object classes 107 and, for each object class, a respective key 104 associated with the object class. The protection controller 710 may provide the content protection indicator 735 to the media generator 720 (e.g., an output generator 722).

The media generator 720 includes an output generator 722. The output generator 722 includes a decryptor 724. The media generator 720 (e.g., the output generator 722) is configured to receive the masked image frame 144, the encrypted ROI content 148, and the content protection indicator 735. In embodiments in which the encoded output data 162 includes an encoded version of the ROI segmentation frame 555, the media generator 720 (e.g., the output generator 722) is also configured to receive the ROI segmentation frame 555 from the decoder 738.

The output generator 722 is configured to generate the output image frame 740 based on the masked image frame 144, or based on a combination of the masked image frame 144 and the encrypted ROI content 148 and/or the ROI segmentation frame 555. For example, the output generator 722 may selectively generate the output image frame 740 based on the encryption indicator 165. To illustrate, in some embodiments, the output generator 722 may output the masked image frame 144 as the output image frame 740, as described further herein at least with reference to FIG. 8A. In other embodiments, the output generator 722 may decrypt the encrypted ROI content 148 to generate decrypted ROI content (e.g., the ROI content 146) that is combined with the masked image frame 144 to generate the output image frame 740, as described further herein at least with reference to FIG. 8B. In some other embodiments, the output generator 722 may decrypt the encrypted ROI content 148 to generate decrypted ROI content (e.g., the ROI content 146) that is combined, based on the ROI segmentation frame 555, with the masked image frame 144 to generate the output image frame 740, as described further herein at least with reference to FIG. 8C.

The decryptor 724 is configured to selectively decrypt or attempt to decrypt the encrypted ROI content 148. For example, the decryptor 724 may selectively decrypt or attempt to decrypt the encrypted ROI content 148 based on the encryption indicator 165, the content protection indicator 735, or a combination thereof. For example, the decryptor 724 may not attempt to decrypt the encrypted ROI content 148 if the content protection data 164 does not include the encryption indicator 165, if a value of the encryption indicator indicates that the encoded output data 162 does not include the encrypted ROI content 148, if the device does not have a key that corresponds to an object class 107 indicated by the content protection data 164, or a combination thereof.

In some embodiments, the decryptor 724 may be configured to decrypt, using a private key, an encrypted key included in the encoded output data 162 (e.g., the content protection data 164) that is encrypted using a public key that corresponds to the private key. The decryptor 724 may then use the decrypted key to decrypt the encrypted ROI content 148.

During operation of the system 700, the processor 108 obtains the encoded output data 162. The encoded output data 162 includes the content protection data 164 and encoded data, such as the encoded data 410. In some embodiments, the encoded output data 162 is associated with media content, such as image data, audio data, or a combination thereof.

The encoded output data 162 is provided to the decoder 738 which decodes the encoded output data 162. Based on decoding the encoded output data 162, the decoder 738 provides the content protection data 164 to the protection controller 710, and provides the masked image frame 144 and the encrypted ROI content 148 to the media generator 720. In some embodiments, the decoder 738 also provides the ROI segmentation frame 555 to the media generator 720 based on decoding the encoded output data 162.

In some embodiments, the decoder 738 and/or the protection controller 710 may identify the encryption indicator 165 included in the content protection data 164. For example, the decoder 738 and/or the protection controller 710 may determine a value of the encryption indicator 165. Additionally, or alternatively, the decoder 738 and/or the protection controller 710 may identify or determine, based on the content protection data 164, the position data 452, a non-display indicator associated with the encrypted data, the masked image frame 144, the ROI segmentation frame 555, or a combination thereof.

The decryptor 724 may decrypt, based on identification of the encryption indicator 165 and based on the key 736, the encrypted ROI content 148 to obtain the ROI content 146. The output generator 722 may modify the masked image frame 144 based on (e.g., to include) the ROI content 146 to generate the output image frame 740. In some embodiments, the output image frame 740 includes or corresponds to the input image frame 142, a bitstream, or a combination thereof. The output image frame 740 may be stored at the memory 106 or sent to another device for output.

In some embodiments in which the encoded output data 162 includes a media container (e.g., an MPEG-4 (MP4) container, an Audio Video Interleave (AVI) container, an MPEG transport stream container, or another multimedia container format), the decoder 738 is configured to access components of the media container to obtain the encoded masked image frame 414, the encoded encrypted ROI content 418, the content protection data 164, the segmentation data, or a combination thereof. For example, the decoder 738 may access a first track of the media container to obtain the encoded masked image frame 414 and a second track of the media container to obtain the encoded encrypted ROI content 418. Additionally, or alternatively, the decoder 738 may access a metadata field of the media container, a supplemental track of the media container, an embedded data field of the media container, or a combination thereof, to obtain the content protection data 164, the segmentation data, or both.

In a particular example, a decoder that is not configured to process the content protection data 164 may decode the first track of the media container to display the masked version of the input media data during playback (e.g., based on the encoded masked image frame 414), while the decoder 738 (which is configured to process the content protection data 164) may access and decode the second track, metadata fields, additional track(s), etc., to obtain the encrypted ROI content 148 and the ROI segmentation frame 155, enabling decryption of the encrypted ROI content 148 based on the key 137 and combining, at the media generator 720, of the decrypted ROI content with the masked image frame 144 to generate the output image frame 740.

In some embodiments, a device (e.g., the device 702) includes one or more processors (e.g., the processor 108) configured to obtain output media data (e.g., the encoded output data 162) associated with media data. The output media data includes encrypted media data (e.g., the encrypted ROI content 148) associated with a portion of the media data that includes an instance of an object class (e.g., the object class 107). The output media data also includes a masked version (e.g., the masked image frame 144) of the media data. The masked version includes a masked portion associated with the portion of the media data. The output media data also includes content protection data (e.g., the content protection data 164). The content protection data includes an encryption indicator (e.g., the encryption indicator 165) that indicates the output media data includes the encrypted media data. The one or more processors are also configured to identify the encryption indicator. The one or more processors are further configured to, based on identification of the encryption indicator, decrypt the encrypted media data to obtain the portion of the media data, and modify the masked version of the media data to include the portion of the media data.

In some examples, the device 702 corresponds to or is included in one of various types of devices, such that the processor 108 can be integrated in multiple types of devices. In an illustrative example, the processor 108 is integrated in a wearable electronic device as depicted in FIG. 12, a virtual reality, mixed reality, or augmented reality headset as depicted in FIG. 15, a mixed reality or augmented reality glasses device as described with reference to FIG. 16, or another wearable device. In another illustrative example, the processor 108 is integrated in a mobile device (a mobile phone or a tablet) as depicted in FIG. 11, a voice-controlled speaker system as depicted in FIG. 13, a camera as depicted in FIG. 14, a vehicle as depicted in FIG. 17 or FIG. 18, a computer (e.g., a laptop computer) or a server, or another system or device.

As described with reference to FIG. 7A, the present disclosure provides techniques for supporting decoding or decryption of media content. For example, one technical advantage of implementing the device 702 as described above is privacy control and content management of sensitive content which may be selectively decrypted based on the encryption indicator 165. To further illustrate the technical advantage, the sensitive content of the media content is masked in the masked image frame 144, which can be displayed or stored by the device 702 based on not having authorization or access to the sensitive content (e.g., the encrypted ROI content 148). In some aspects, device 702 is authorized to access the sensitive content and decrypts the encrypted ROI content 148 to obtain (e.g., recover) the sensitive content. The sensitive content may then be combined with the masked image frame 144 to obtain the output image frame 740—e.g., to recreate the original media content (e.g., the input image frame 142). In some embodiments, the operations described with reference to the system 700 may be applied to provide automatic sensitive content (partial video) decryption. The partial video decryption, through use of the encryption indicator 165, can allow for both authorized and non-authorized access of encrypted content using the same encoded output data 162 (e.g., the same encrypted bitstream).

FIG. 7B is a diagram of an example of operations 780 that may be performed at the system of FIG. 7A, such as at the decoder 738, the protection controller 710, and the media generator 720. The operations 780 include starting a decode process of a bitstream, at block 782. For example, an encoded video bitstream can be received at the decoder 738 as the encoded output data 162.

At block 784, a determination is made as to whether the decoder that receives the bitstream is “aware of” encryption. As used herein, a decoder is aware of encryption when the decoder is configured to detect that the bitstream includes encrypted content (e.g., such as the decoder 738 that is configured to detect the encryption indicator 165), and a decoder is not aware of encryption when the decoder is not configured to detect that the bitstream includes encrypted content (e.g., a “legacy” or “standard” decoder that is not configured to detect the encryption indicator 165).

Based on the decoder not being aware of encryption, standard decoding processing is performed on the bitstream, at block 786. For example, any encrypted content in the bitstream that is associated with a no-display SEI is ignored when generating the decoded output. Thus, when a bitstream includes the masked image frame 144 and the encrypted ROI content 148, the resulting output image frame corresponds to the masked image frame 144, while the encrypted ROI content 148 is unused (e.g., discarded or ignored).

Based on the decoder being aware of encryption, a determination is made as to whether an encryption indicator is detected in the bitstream, at block 788. For example, the decoder 738 detects whether the encoded output data 162 includes the encryption indicator 165. Based on no encryption indicator being detected, standard decoding processing is performed on the bitstream, at block 786.

Based on an encryption indicator being detected, a determination is made as to whether decryption has been enabled and whether an appropriate key is available for decryption, at block 790. For example, the in some embodiments the device 702 is responsive to a user input (e.g., received via a user interface, or one or more selectable application settings) that indicates whether protected content is to be shown during playout (via decryption and insertion into the respective ROI) or if instead the masked content is to be shown during playout. Based on decryption not being enabled, an appropriate key not being available to decrypt, or both, standard decoding processing is performed on the bitstream, at block 786.

Otherwise, when decryption is enabled and a key is available, frames associated with non-display flags are processed, and encrypted content is decrypted and placed into respective ROIs for playout. For example, based on user enabled decryption and based on the key 736, the decryptor 724 may decrypt the encrypted ROI content 148 to obtain the ROI content 146. The output generator 722 may modify the masked image frame 144 based on (e.g., to include) the ROI content 146 to generate the output image frame 740.

FIGS. 8A, 8B, 8C, and 8D are block diagrams to illustrate operations associated with the system of FIG. 7A. For example, FIG. 8A illustrates operations to provide the masked image frame 144 as the output image frame 740A. Additionally, FIG. 8B illustrates operations to generate the output image frame 740B as a combination of the ROI content 146 and the masked image frame 144. Further, FIG. 8C illustrates operations to generate the output image frame 740C as a combination of or based on the ROI content 146, the masked image frame 144, and the ROI segmentation frame 555. FIG. 8D illustrates operations to selectively generate the output image frame 740D as the masked image frame 144, or as a combination of at least the ROI content 146 and the masked image frame 144.

With reference to FIGS. 8A, 8B, 8C, and 8D, the decoder 738 includes a parser/transformer 804 and a reconstructor 806. The parser/transformer 804, such as a bitstream parser or an inverse transformer, is configured to parse the encoded output data 162 to identify the content protection data 164 and the encoded data 410 included in the encoded output data 162. The reconstructor 806 is configured to reconstruct (e.g., decode) the encoded data 410 to obtain the masked image frame 144, the encrypted ROI content 148, the ROI segmentation frame 555, or a combination thereof.

Referring to FIG. 8A, the decoder 738 is configured to provide the masked image frame 144 and the encrypted ROI content 148, based on the encoded output data 162, to the output generator 722. The output generator 722 outputs the masked image frame 144 as the output image frame 740A based on the encryption indicator 165, based on a lack of a key to decode the encrypted ROI content 148, or a combination thereof. For example, the output generator 722 can include a decryption controller 810 configured to determine that decryption is not to be performed, such as due to the absence of encrypted content based on the encryption indicator 165 (e.g., from the decoder 738), or because the device 702 does not include a decryption key needed to decrypt the encrypted ROI content 148. As a result, the decryption controller 810 initiates a masked image passthrough 812 that causes the masked image frame 144 to be output as the output image frame 740A and any non-display frames, such as the encrypted ROI content 148, to be discarded.

Referring to FIG. 8B, the decoder 738 is configured to provide the masked image frame 144 and the encrypted ROI content 148, based on the encoded output data 162, to the output generator 722. The decryption controller 810 may determine that the decryption is to be performed, such as when the encryption indicator 165 indicates the presence of encrypted content and the device 702 includes a decryption key to decrypt the encrypted ROI content 148. The output generator 722 includes the decryption controller 810, the decryptor 724 and an ROI positioner 886. The decryptor 724 is configured to decrypt, based on the key 736, the encrypted ROI content 148 to obtain the ROI content 146 that is provided to the ROI positioner 886. The ROI positioner 886 is configured to combine the ROI content 146 with the masked image frame 144 to generate the output image frame 740B. In some embodiments, the ROI positioner 886 combines the ROI content 146 and the masked image frame 144 based on position data, such as the position data 452.

Referring to FIG. 8C, the decoder 738 is configured to provide the masked image frame 144, the encrypted ROI content 148, and the ROI segmentation frame 555, based on the encoded output data 162, to the output generator 722. The decryption controller 810 may determine that the decryption is to be performed, such as when the encryption indicator 165 indicates the presence of encrypted content and the device 702 includes a decryption key to decrypt the encrypted ROI content 148. The output generator 722 includes the decryption controller 810, an ROI extractor and vectorizer 820, the decryptor 724, an ROI regenerator 823, and the ROI positioner 886. The ROI extractor and vectorizer 820 is configured to, for each ROI included in or indicated by the ROI segmentation frame 555, perform a raster scan to generate an ROI vector 895, such as a 1D vector.

The decryptor 724 is configured to decrypt the ROI vector 895 based on the key 736 to generate a decrypted ROI content that is provided to the ROI regenerator 823. The decrypted ROI content may be a 1D vector. The ROI regenerator 823 may generate ROI content based on the decrypted ROI content and the ROI segmentation frame 555.

For example, the ROI regenerator 823 may generate the ROI content in 2D based on the decrypted ROI content and the ROI segmentation frame 555. The ROI content is provided to the ROI positioner 886 which is configured to combine the ROI content with the masked image frame 144 based on the ROI segmentation frame 555, such as by overwriting or replacing masked image pixels of a ROI in the masked image frame 144 with the ROI content from the ROI regenerator 823, to generate the output image frame 740C.

Referring to FIG. 8D, the output generator 722 includes a decryption switch 890 that is configured to selectively route decoded bitstream data for non-decryption output processing 896 or for decryption output processing 898. To illustrate, the decoder 738 is configured to provide the masked image frame 144, the encrypted ROI content 148, and the ROI segmentation frame 555, based on the encoded output data 162, to the output generator 722. The decryption switch 890 determines whether to perform the non-decryption output processing 896 or the decryption output processing 898 based on one or more factors, such as whether the encryption indicator 165 is in the encoded output data 162, whether the content protection data 164 indicates the key 736 (or another one of the one or more keys 104) is operable to decrypt the encrypted ROI content 148, whether a user of the device has enabled or disabled decryption for media playout, etc. In a particular embodiment, the decryption switch 890 is configured to perform one or more of the operations 780 of FIG. 7B.

The decryption output processing 898 includes an ROI extraction and vectorization of the encrypted ROI content 148 at the ROI extractor and vectorizer 820, decryption of the ROI vector 895 at the decryptor 724, generation of the ROI content, at the ROI regenerator 823, based on based on the decrypted ROI vector and the ROI segmentation frame 555, and combining the ROI content with the masked image frame 144 based on the ROI segmentation frame 555, at the ROI positioner 886, to generate an output image frame 740D that includes the sensitive content without masking, in a similar manner as described with reference to FIG. 8C. In contrast, the non-decryption output processing 896 includes processing the masked image frame 144 to generate an output image frame 740D that has masked ROI portions, or may be a pass-through of the masked image frame 144 as the output image frame 740D without additional processing, in a similar manner as described with reference to FIG. 8A.

FIG. 9 is a block diagram of an example of a system 900 to encrypt and decrypt media content, in accordance with one or more aspects of the present disclosure. The system 900 includes a device 902 that is configured to or is operable to encrypt and/or decrypt media content. In some embodiments, the device 902 includes or corresponds to the device 102 or the device 702.

The device 902 includes, or is coupled to, a memory 106 (e.g., a memory device), one or more processors 108 (collectively referred to herein as the “processor 108”), an image sensor 912, an input device 914, a display device 916, a speaker 917, and a modem 918. The memory 106 may include one or more memory devices, such as a single memory or multiple different memory devices (of the same type or of different types).

The memory 106 is configured to store instructions 109 and a content encryption configuration 130. The instructions 109, when executed by the processor 108, cause the processor 108 to perform one or more operations as described herein. The content encryption configuration 130 includes the object class 107 and the key 104. In some examples, the memory 106 stores other information or data, such as media content. The media content can include or indicate audio content, video content, or a combination thereof. In some examples, the stored media content includes at least an encrypted portion.

The processor 108 includes a protection controller 910, a media generator 920, an encoder 928, and a decoder 938. Each of the protection controller 910, the media generator 920, the encoder 928, and the decoder 938, or a portion thereof, may be implemented by the processor 108 executing instructions (e.g., software), dedicated hardware (e.g., circuitry), or a combination thereof. The protection controller 910, the media generator 920, the encoder 928, and the decoder 938 may include or correspond to the protection controller 110 or 710, the media generator 120 or 720, the encoder 128, and the decoder 738, respectively. It is noted that although the device 902 is described as including both the encoder 928 and the decoder 938, in other embodiments, the device 902 may include one of the encoder 928 and the decoder 938. For example, the device 902 may include the encoder 928 and not the decoder 938, such that the device 902 is configured to encrypt and/or encode at least a portion of media content. As another example, the device 902 may include the decoder 938 and not the encoder 928, such that the device 902 is configured to decode and/or decrypt encoded media content.

The modem 918 is coupled to the processor 108 and is configured to transmit or receive media content (e.g., the encoded output data 162). For example, the modem 918 may transmit the media content to a second device, or receive the media content from second device.

The processor 108 is also coupled to an image sensor 912, an input device 914 (e.g., a microphone, a keyboard or touch screen, etc.), a display device 916, and a speaker 917. The image sensor 912 may include one or more cameras and may be configured to generate input media data, such as the image data 140 or the input image frame 142. Video content, such as the encoded output data 162, may be generated by the processor 108 at least partially based on the input media data.

The input device 914 is configured to receive an input and provide the input to the processor 108 as input data 915. For example, the input device 914 may include a keyboard, a touch screen, or a microphone configured to receive the input and provide the input data 915 (e.g., an input signal) to the processor 108. The input data 915 may indicate to store or modify an entry at the content encryption configuration 130, generate image data 140, store or transmit the encoded output data 162, decode and/or decrypt the encoded output data 162, or present the encoded output data 162 or the output image frame 740. In some implementations, the image sensor 912 (e.g., one or more cameras) may generate the image data 140 based on the input data 915.

The display device 916 is coupled to the processor 108 and is configured to output the output image frame 740 generated based on the encoded output data 162. For example, the display device 916 may output display data based on the output image frame 740 (e.g., output media data). In some examples, the display device 916 includes a display screen, a monitor or television, a projector, or a combination thereof. In some embodiments, the device 902 (e.g., the processor 108) is configured to output audio associated with the output image frame 740 (e.g., video content). The speaker 917 is coupled to the processor 108 and is configured to output audio associated with associated with the output image frame 740 (e.g., video content).

The image sensor 912, the input device 914, the display device 916, the speaker 917, or a combination there may be coupled to or integrated within the device 902. Although the device 902 is described as being coupled to or including the image sensor 912, the input device 914, the display device 916, the speaker 917, and the modem 918, in other embodiments, one or more of these elements are optional, and in such embodiments, the device 902 may not include or be coupled to the image sensor 912, the input device 914, the display device 916, the speaker 917, the modem 918, or a combination thereof.

During operation of the system 900, the processor 108 may perform one or more operations to identify and encrypt media content. For example, the processor 108 may use the protection controller 910, the media generator 920, and the encoder 928 to perform one or more operations as described herein at least with reference to FIGS. 1-6 to identify and encrypt media content. Additionally, or alternatively, during operation of the system 900, the processor 108 may perform one or more operations to decrypt media content. For example, the processor 108 may use the protection controller 910, the media generator 920, and the decoder 938 to perform one or more operations as described herein at least with reference to FIG. 7 or 8A-8C to decrypt media content that is encrypted.

In some embodiments, a device (e.g., the device 902) includes one or more processors (e.g., the processor 108) configured to obtain input media data that includes an instance of the object class. The one or more processors are also configured to encrypt a portion of the input media data that includes the instance of the object class to generate encrypted media data. The one or more processors are also configured to mask the portion of the input media data to generate a masked version of the input media data, and generate output media data. The output media data includes the masked version of the input media data, the encrypted media data, and content protection data. The content protection data includes an encryption indicator that indicates the output media data includes the encrypted media data.

In some embodiments, a device (e.g., the device 902) includes one or more processors (e.g., the processor 108) configured to obtain output media data that includes encrypted media data associated with a portion of media data that includes an instance of an object class; a masked version of the media data, the masked version includes a masked portion associated with the portion of the media data; and content protection data, the content protection data includes an encryption indicator that indicates the output media data includes the encrypted media data. The one or more processors are also configured to identify the encryption indicator. The one or more processors are also configured to, based on identification of the encryption indicator, decrypt the encrypted media data to obtain the portion of the media data, and modify the masked version of the media data to include the portion of the media data.

In some examples, the device 902 corresponds to or is included in one of various types of devices, such that the processor 108 can be integrated in multiple types of devices. In an illustrative example, the processor 108 is integrated in a wearable electronic device as depicted in FIG. 12, a virtual reality, mixed reality, or augmented reality headset as depicted in FIG. 15, a mixed reality or augmented reality glasses device as described with reference to FIG. 16, or another wearable device. In another illustrative example, the processor 108 is integrated in a mobile device (a mobile phone or a tablet) as depicted in FIG. 11, a voice-controlled speaker system as depicted in FIG. 13, a camera as depicted in FIG. 14, a vehicle as depicted in FIG. 17 or FIG. 18, a computer (e.g., a laptop computer) or a server, or another system or device.

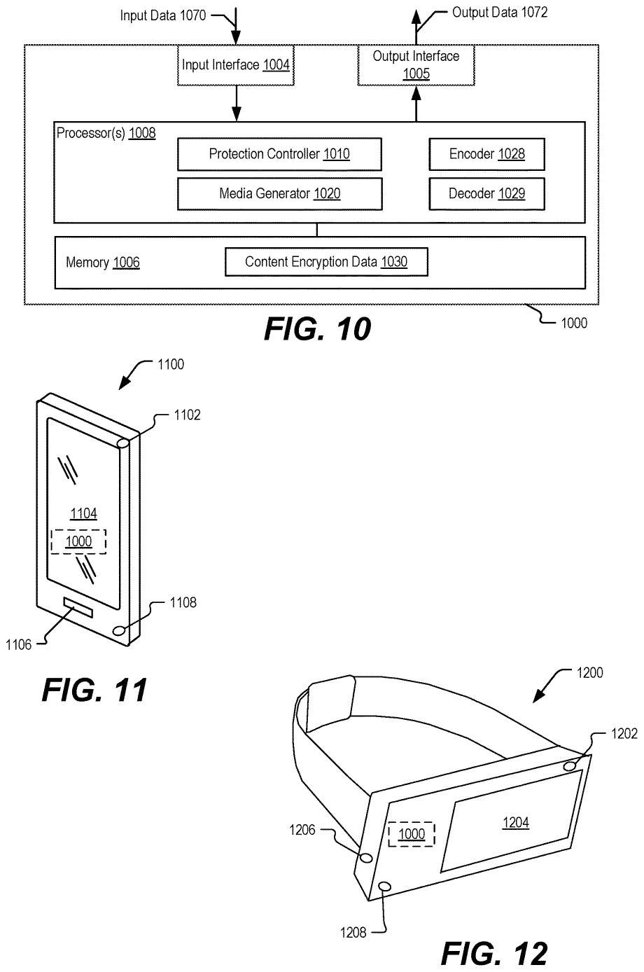

FIG. 10 depicts a diagram of an example of an integrated circuit 1000 operable to encrypt or decrypt media content, in accordance with some examples of the present disclosure. The integrated circuit 1000 includes one or more processors 1008 (herein after referred to as the “processor 1008”) and a memory 1006. The processor 1008 and the memory 1006 may include or correspond to the processor 108 and the memory 106, respectively. The processor 1008 may include a protection controller 1010, a media generator 1020, an encoder 1028, a decoder 1029, or a combination thereof. The protection controller 1010, the media generator 1020, the encoder 1028, and the decoder 1029 may include or correspond to the protection controller 110, 710, or 910, the media generator 120, 720, or 920, the encoder 128 or 928, and the decoder 738 or 938, respectively. The memory 1006 includes (e.g., stores) content encryption data 1030. The content encryption data 1030 may include or correspond to the content encryption configuration 130.

The integrated circuit 1000 also includes an input interface 1004, such as one or more bus interfaces, to enable the integrated circuit 1000 to receive signals representing input data 1070 for processing. For example, the input data 1070 can correspond to or include the image data 140, the input image frame 142, the content protection indicator 135, the combined output data 160, the encoded output data 162, the content encryption configuration 130, or a combination thereof.

The integrated circuit 1000 also includes an output interface 1005, such as a bus interface, to enable the integrated circuit 1000 to output signals representing output data 1072. For example, the output data 1072 can correspond to or include the image data 140, the input image frame 142, the content protection indicator 135, the combined output data 160, the encoded output data 162, the content encryption configuration 130, or a combination thereof.

The integrated circuit 1000 including the protection controller 1010, the media generator 1020, the encoder 1028, and the decoder 1029, or a combination thereof, and the content encryption configuration 130 enables implementation of encryption or decryption of media content as a component in a system or a device. For example, the system or the device may include a mobile device (e.g., a mobile phone or tablet) as depicted in FIG. 11, a wearable electronic device as depicted in FIG. 12, a voice-controlled speaker system as depicted in FIG. 13, a camera as depicted in FIG. 14, a virtual reality, mixed reality, or augmented reality headset as depicted in FIG. 15, a mixed reality or augmented reality glasses device, as described with reference to FIG. 16, or a vehicle as depicted in FIG. 17 or FIG. 18.

In some embodiments, the system or the device that includes the integrated circuit 1000 also includes or is coupled to an image sensor (e.g., a camera), an input device (e.g., a microphone, a keyboard or touch screen, etc.), a display device, a speaker, a modem, or a combination thereof. For example, the image sensor, the input device, the display device, the speaker, and the modem may include or correspond to the image sensor 912, the input device 914, the display device 916, the speaker 917, and the modem 918, respectively.

In some embodiments, the system or the device that includes the integrated circuit 1000 is operable to detect an instance of an object class within input media data; encrypt, based on a key, a portion of the input media data that includes the instance of the object class to generate encrypted media data; mask the portion of the input media data to generate a masked version of the input media data; and generate output media data that includes the masked version of the input media data, the encrypted media data, and content protection data including an encryption indicator that indicates the output media data includes the encrypted media data.

In some embodiments, the system or the device that includes the integrated circuit 1000 is operable to obtain output media data associated with media data. The output media data includes encrypted media data associated with a portion of the media data encrypted based on a key, the encrypted media data associated with an instance of an object class; a masked version of the media data, the masked version includes a masked portion associated with the portion of the media data; and content protection data including an encryption indicator that indicates the output media data includes the encrypted media data. The system or the device that includes the integrated circuit 1000 is further operable to identify the encryption indicator; decrypt, based on identification of the encryption indicator and based on the key, the encrypted media data to obtain the portion of the media data; and modify the masked version of the media data to include the portion of the media data.

FIG. 11 depicts a diagram of a mobile device 1100 operable to encrypt or decrypt media content, in accordance with some examples of the present disclosure. The mobile device 1100 may include or correspond to a phone or a tablet computer device, as illustrative, non-limiting examples. The mobile device 1100 includes a camera 1102 (e.g., an image sensor), a display 1104 (e.g., a display screen), a microphone 1106, a speaker 1108, and the integrated circuit 1000. Components of the integrated circuit 1000, including the protection controller 1010, the media generator 1020, the encoder 1028, the decoder 1029, or a combination thereof, are integrated in the mobile device 1100 and are illustrated using dashed lines to indicate internal components that are not generally visible to a user of the mobile device 1100.

FIG. 12 depicts a diagram of a wearable electronic device 1200 operable to encrypt or decrypt media content, in accordance with some examples of the present disclosure. The wearable electronic device 1200 may include or correspond to a “smart watch,” as an illustrative, non-limiting example. The wearable electronic device 1200 includes a camera 1202 (e.g., an image sensor), a display 1204 (e.g., a display screen), a microphone 1206, a speaker 1208, and the integrated circuit 1000. Components of the integrated circuit 1000, including the protection controller 1010, the media generator 1020, the encoder 1028, the decoder 1029, or a combination thereof, are integrated in the wearable electronic device 1200 and are illustrated using dashed lines to indicate internal components that are not generally visible to a user of the wearable electronic device 1200.

FIG. 13 is a diagram of a voice-controlled speaker system 1300 operable to encrypt or decrypt media content, in accordance with some examples of the present disclosure. The voice-controlled speaker system 1300 may include or correspond to a wireless speaker and voice activated device, as an illustrative, non-limiting example. The voice-controlled speaker system 1300 can have wireless network connectivity and is configured to execute an assistant operation. The voice-controlled speaker system 1300 includes a camera 1302 (e.g., an image sensor), a display 1304 (e.g., a display screen), a microphone 1306, a speaker 1308, and the integrated circuit 1000. Components of the integrated circuit 1000, including the protection controller 1010, the media generator 1020, the encoder 1028, the decoder 1029, or a combination thereof, are integrated in the voice-controlled speaker system 1300 and are illustrated using dashed lines to indicate internal components that are not generally visible to a user of the voice-controlled speaker system 1300.

FIG. 14 is a diagram of a camera device 1400 operable to encrypt or decrypt media content, in accordance with some examples of the present disclosure. The camera device 1400 includes an image sensor 1402, a display 1404 (e.g., a display screen), a microphone 1406, a speaker 1408, and the integrated circuit 1000. Components of the integrated circuit 1000, including the protection controller 1010, the media generator 1020, the encoder 1028, the decoder 1029, or a combination thereof, are integrated in the camera device 1400 and are illustrated using dashed lines to indicate internal components that are not generally visible to a user of the camera device 1400.

FIG. 15 is a diagram of a headset 1500, such as a virtual reality, mixed reality, or augmented reality headset, operable to encrypt or decrypt media content, in accordance with some examples of the present disclosure. A visual interface device is positioned in front of the user's eyes to enable display of augmented reality, mixed reality, or virtual reality images or scenes to the user while the headset 1500 is worn. The headset 1500 also includes a camera 1502 (e.g., an image sensor), a display 1504 (e.g., a display screen), a microphone 1506, a speaker 1508, and the integrated circuit 1000. Components of the integrated circuit 1000, including the protection controller 1010, the media generator 1020, the encoder 1028, the decoder 1029, or a combination thereof, are integrated in the headset 1500 and are illustrated using dashed lines to indicate internal components that are not generally visible to a user of the headset 1500.

FIG. 16 is a diagram of a mixed reality or augmented reality glasses device 1600 operable to encrypt or decrypt media content, in accordance with some examples of the present disclosure. The glasses 1600 include a holographic projection unit 1604 configured to project visual data onto a surface of a lens 1605 or to reflect the visual data off of a surface of the lens 1605 and onto the wearer's retina. The glasses 1600 also include a camera 1602 (e.g., an image sensor), a microphone 1606, one or more speakers 1608, and the integrated circuit 1000. Components of the integrated circuit 1000, including the protection controller 1010, the media generator 1020, the encoder 1028, the decoder 1029, or a combination thereof, are integrated in the glasses 1600 and are illustrated using dashed lines to indicate internal components that are not generally visible to a user of the glasses 1600.

FIG. 17 is a diagram of a first example of a vehicle 1700 operable to encrypt or decrypt media content, in accordance with some examples of the present disclosure. The vehicle 1700 may include or correspond to a manned or unmanned aerial device (e.g., a package delivery drone). The vehicle 1700 includes a camera 1702 (e.g., an image sensor), a display 1704 (e.g., a display screen), a microphone 1706, a speaker 1708, and the integrated circuit 1000. Components of the integrated circuit 1000, including the protection controller 1010, the media generator 1020, the encoder 1028, the decoder 1029, or a combination thereof, are integrated in the vehicle 1700 and are illustrated using dashed lines to indicate internal components that are not generally visible to a user of the vehicle 1700.

FIG. 18 is a diagram of a second example of a vehicle 1800 operable to encrypt or decrypt media content, in accordance with some examples of the present disclosure. The vehicle 1800 may include or correspond to a car. The vehicle 1800 includes a camera 1802 (e.g., an image sensor), a display 1804 (e.g., a display screen), a microphone 1806, one or more speakers 1808, and the integrated circuit 1000. Components of the integrated circuit 1000, including the protection controller 1010, the media generator 1020, the encoder 1028, the decoder 1029, or a combination thereof, are integrated in the vehicle 1800 and are illustrated using dashed lines to indicate internal components that are not generally visible to a user of the vehicle 1800.

Although the examples of the vehicle of FIGS. 17 and 18 are describe an aerial device and a car, respectively, in other examples, the vehicle can correspond to an aircraft (such as a fixed wing aircraft, a rotary wing aircraft, an aerostat, a hybrid aircraft, spaceship, or another type of aircraft), a land craft (such as a car, a truck, or another type of land craft), or a watercraft (such as a boat, a submersible, a ship, a barge, a ferry, or another type of watercraft). Further, the watercraft, the aircraft, the land craft, or watercraft can be manned or unmanned (e.g., crewed or uncrewed).

In a particular example of one or more of the devices of FIGS. 11-18, the integrated circuit 1000 (e.g., the media generator 1020 and the encoder 1028) is operable to generate media data (e.g., the encoded output data 162) that includes the content protection data 164. For example, based on media content received from a camera or a speaker of the device, the media generator 1020 generates the masked image frame 144 and the encrypted ROI content 148. Additionally, the encoder 1028 generates the encoded output data 162, such as a bitstream, that includes or indicates the masked image frame 144, the encrypted ROI content 148, and the content protection data 164 including the encryption indicator 165 which indicates that the encoded output data 162 includes the encrypted ROI content 148. In some embodiments, the encryption indicator 165 indicates that that the encoded output data 162 includes the encrypted ROI content 148 which may be decrypted and combined with the masked image frame 144 to obtain the input image frame 142. The encoded output data 162 may be stored at the memory 1006, sent to another device via a modem coupled to the integrated circuit 1000, output via a display or speaker of the one or more devices of FIG. 9 or 11-18, or a combination thereof. One technical advantage of the integrated circuit 1000 (e.g., the media generator 1020) implemented by the one or more devices of FIGS. 11-18 as described above is that automatic sensitive content (partial video) encryption may be performed on the input image frame 142, such as when the video is captured for the first time. The partial video encryption, through use of the encryption indicator 165, can allow for storge, transmission, and playback using the same encoded output data 162 (e.g., the same encrypted bitstream) both where access to encrypted ROI content 148 is authorized (e.g., playback includes unencrypted sensitive content) and where access to the encrypted ROI content 148 is non-authorized (e.g., playback includes a masked version of the sensitive content).

In a particular example of one or more of the devices of FIGS. 11-18, the integrated circuit 1000 (e.g., the media generator 1020 and the decoder 1029) is operable to selectively decode the encoded output data 162 and decrypt the encrypted ROI content 148. For example, the decoder 1029 may receive and decode the encoded output data 162 and identify the encryption indicator 165 included in the encoded output data 162. Based on the identified encryption indicator 165, the media generator 1020 decrypts the encrypted ROI content 148 based on the key 137. The media generator 1020 can then combine the decrypted ROI content (e.g., the ROI content 146) with the masked image frame 144 and thereby obtain the original input image frame 142. The obtained original input image frame 142 may be stored at the memory 1006, sent to another device via a modem coupled to the integrated circuit 1000, output via a display or speaker of the one or more devices of FIG. 9 or 11-18, or a combination thereof. It is noted that if the key 137 is unavailable to decrypt the encrypted ROI content 148, the masked image frame 144 may be displayed, or the encrypted ROI content 148 and the masked image frame 144 may be stored at the memory 1006. One technical advantage of the integrated circuit 1000 (e.g., the media generator 1020) implemented by the one or more devices of FIGS. 11-18 as described above is that the same encoded output data 162 (e.g., the same encrypted bitstream) that includes the content protection data 164, can allow for storage, transmission, and/or playback of media content, with sensitive content either being masked or non-masked based on whether access to the encrypted ROI content 148 is authorized or non-authorized.

The embodiments of the systems or devices as described with reference to FIGS. 10-18 are described, respectively, as including a display, a microphone, a speaker, a camera, or a combination thereof. As described with reference to FIGS. 10-18, the display, the microphone, the speaker, and the camera may include or correspond to the display device 916, the input device 914, the speaker 917, and the image sensor 912, respectively. It is noted that in other embodiments of the systems or devices of FIGS. 10-18, one or more of the systems or devices of FIGS. 10-18 may not include the display, the microphone, the speaker, the camera, or a combination thereof. Additionally, or alternatively, one or more of the systems or devices of FIGS. 10-18 may include an additional component. For example, the additional component may include a modem, such as the modem 918.

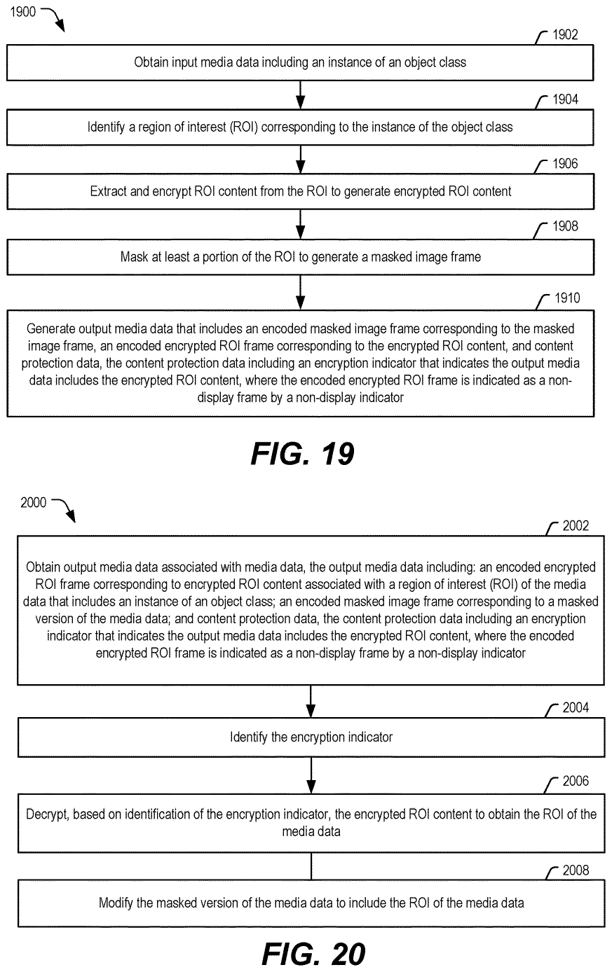

FIG. 19 is a diagram of an example of a method 1900 of encryption of media content, in accordance with some aspects of the present disclosure. In a particular aspect, one or more operations of the method 1900 are performed by the system 100, the device 102, the processor 108, the protection controller 110, the media generator 120, the encoder 128, the device 902, the protection controller 910, the media generator 920, the encoder 928, the integrated circuit 1000, the protection controller 1010, the media generator 1020, the encoder 1028, the mobile device 1100, the wearable electronic device 1200, the voice-controlled speaker system 1300, the camera device 1400, the headset 1500, the glasses 1600, the vehicle 1700 or 1800, or a combination thereof.

In some embodiments, the method 1900 includes, at block 1902, obtaining input media data including an instance of an object class. For example, the object class may include or correspond to the object class 107. The input media data may include or correspond to the image data 140 or the input image frame 142 or 242. The input media data may include image data, audio data, or a combination thereof. In some examples, the input media data represents an image frame.

In some embodiments, to obtain the input media data, the method 1900 may include receiving or retrieving the input media data from a memory, such as the memory 106. In other embodiments, to obtain the input media data, the method 1900 may include receiving the input media data from a generation device, such as a camera, a microphone, or a combination thereof. For example, in some embodiments, the method 1900 includes generating, by one or more cameras, the input media data. The one or more cameras may include or correspond to the image sensor 912. In some such embodiments, the method 1900 includes receiving, via an input device, an input and providing the input to a processor (e.g., the processor 108). For example, the input device and the input may include or correspond to the input device 914 and the input data 915, respectively. In some implementations, the input includes a request to generate the input media data. The method 1900 may include activating, based on the input data, the one or more cameras to generate the input media data.

At block 1904, the method 1900 includes identifying a region of interest (ROI) corresponding to the instance of the object class (e.g., identifying a portion of the input media data that includes the instance of the object class). The ROI may correspond to a portion of the input media data that includes the instance of the object class. For example, the content encryption configuration 130 indicates the object class 107, and the ROI identifier 121 processes the input image frame 142 to detect when an instance of an object having the object class 107 is in the input image frame 142. The ROI identifier 121 may identify one or more ROIs in the input image frame 142 based on the detected instance.

At block 1906, the method 1900 includes extracting and encrypting ROI content (e.g., data from the portion of the input media data) from the ROI to generate encrypted ROI content (e.g., encrypted media data). In a particular embodiment, encrypting the ROI content extracted from the ROI is based on a key, which may include or correspond to the key 104 or 137. In an example, the encrypted ROI content includes or corresponds to the encrypted ROI content 148, the encoded encrypted ROI content 418, or the encrypted ROI frame 248 or 536.

At block 1908, the method 1900 further includes masking at least a portion of the ROI (e.g., masking the portion of the input media data) to generate a masked image frame (e.g., a masked version of the input media data). In some examples, the masked image frame includes or corresponds to the masked image frame 144 or 244 or the encoded masked image frame 414.

At block 1910, the method 1900 includes generating output media data that includes: an encoded masked image frame (e.g., the masked version of the input media data, encoded) corresponding to the masked image frame; an encoded encrypted ROI frame (e.g., the encrypted media data, encoded) corresponding to the encrypted ROI content; and content protection data, the content protection data including an encryption indicator that indicates the output media data includes the encrypted ROI content (e.g., the encrypted media data). The encoded encrypted ROI frame is indicated as a non-display frame by a non-display indicator. In a particular embodiment, the content protection data corresponds to the content protection data 164, and the encryption indicator corresponds to the encryption indicator 165. In some examples, the output media data includes or corresponds to one or more of the masked image frame 144 or 244, the encrypted ROI content 148 or 532, the combined output data 160, the encoded output data 162, the content protection data 164, the encrypted ROI frame 248, the encoded masked image frame 414, the encoded encrypted ROI content 418, the encoded segmentation frame 455, the encrypted ROI frame 536, or the ROI segmentation frame 555.

In some embodiments, the encoded masked image frame includes or corresponds to an encoded version of the masked image frame 144 encoded by the encoder 128. The encoded encrypted ROI frame includes or corresponds to an encoded version of the encrypted ROI content 148 encoded by the encoder 128. The non-display indicator may include or correspond to a no display supplemental enhancement information (SEI) message (e.g., the no display SEI 486) included in a frame header (e.g., the header 494) of the encoded encrypted ROI frame (e.g., the encoded encrypted ROI frame 492).

In a particular embodiment, the output media data includes a bitstream, and the content protection data is included in metadata of the bitstream, one or more frame headers in the bitstream, or a combination thereof. For example, the output media data can correspond to the bitstream 499, and the content protection data can correspond to, or include, one or more data values in the sequence data 470 (e.g., the encryption indicator 165, the encryption parameters 472, or both), one or more data values in the header 494 (e.g., the encrypted ROI segmentation frame flag 495, the no display SEI 486, the frame ID 487, the encryption parameters 496, or a combination thereof), one or more data values in the header 484 (e.g., the ROI segmentation frame flag 485, the no display SEI 486, the frame ID 487, the ROI ID data 488, or a combination thereof), or any combination thereof. According to an embodiment, the content protection data can correspond to data in any of the fields described in Table 1, Table 2, and Table 3.

In a particular embodiment, the output media data includes a sequence of image frames, such as encoded frames included in the bitstream 499, and sequence data associated with the sequence of image frames, such as the sequence data 470. In an example, the sequence data includes the encryption indicator, such as the encryption indicator 165 in the sequence data 470.

In some embodiments, the sequence data includes one or more encryption parameters associated with the sequence of image frames, such as the encryption parameters 472 in the sequence data 470. The one or more encryption parameters can include an encryption algorithm identifier, an encryption mode, a total encryption parameter size, one or more encryption algorithm parameter values, or a combination thereof, as described with reference to Table 1. In some examples, the one or more encryption parameters can include an alphabet size, a maximum block size, an input data bit-width, a public key certificate, a certificate authority, a digital signature, or a combination thereof.

In some embodiments, the output media data includes a masked image frame that includes the masked version of the input media data and a frame header that includes a display order frame identifier that indicates a display order of the masked image frame in the sequence. For example, the encoded masked image frame 474 in the bitstream 499 includes the encoded pixel data 480 (e.g., encoded pixel data of the masked image frame 144), and the header 476 incudes the display order frame ID 478.

In a particular embodiment, the output media data includes a non-display indicator associated with the encrypted media data. In an example, the output media data includes an encrypted ROI frame that includes the encrypted media data and a frame header that includes the non-display indicator associated with the encrypted media data, such as the no display SEI 486 in the header 494 of the encoded encrypted ROI frame 492. In some embodiments, the encoded encrypted ROI frame (e.g., the encoded encrypted ROI frame 492) is indicated as a non-display frame by the non-display indicator (e.g., the no display SEI 486). A decoder that is not aware of encryption may ignore the encoded encrypted ROI frame based on the non-display indicator. In some embodiments, the output media data is compliant with a video coding standard (e.g., H.264, H.265, H.266, AV1, or another video coding standard), and the non-display indicator is configured such that a decoder not aware of encryption ignores the encoded encrypted ROI frame and outputs only the encoded masked image frame for display. In some examples, the frame header can include a flag that identifies the frame header as belonging to an encrypted ROI frame, such as the encrypted ROI segmentation frame flag 495. In some examples, the frame header can include a display order frame identifier that corresponds to the masked image frame, such as the frame ID 487 in the header 494 that corresponds to the display order frame ID 478 of the encoded masked image frame 474. In some examples, the frame header includes encryption parameters associated with one or more encrypted ROIs in the encrypted ROI frame, such as the encryption parameters 496.

In a particular embodiment, the method 1900 includes generating segmentation data based on the instance of the object class in the input media data, and the output media data includes the segmentation data. For example, the segmentation data may include or correspond to the encoded segmentation frame 455, the ROI segmentation frame 555, or a combination thereof. In some such embodiments, the output media data includes the segmentation data. Additionally, the output media data may include a non-display indicator (e.g., the non-display indicator 431) associated with the segmentation data. In some embodiments, the encoded segmentation frame (e.g., the encoded segmentation frame 482) is also indicated as a non-display frame by the non-display indicator.

In a particular example, the encoded segmentation frame 482 in the bitstream 499 includes the encoded pixel data 490 (e.g., encoded pixel data of the segmentation frame 655), and the header 484 of the encoded segmentation frame 482 includes the no display SEI 486 associated with the segmentation data. In some embodiments, the non-display indicator comprises a no-display supplemental enhancement information (SEI) message included in a frame header of the encoded segmentation frame, the encoded encrypted ROI frame, or both.

In some examples, the frame header includes a flag that identifies the frame header as belonging to a segmentation frame, such as the ROI segmentation frame flag 485. In some examples, the frame header includes a display order frame identifier that corresponds to the masked image frame, such as the frame ID 487 in the header 484 that corresponds to the display order frame ID 478 of the encoded masked image frame 474. In some embodiments, the frame header includes ROI identification data associated with one or more ROIs in the segmentation frame, such as the ROI ID data 488. In an example, a unique identifier is assigned to each ROI in the input media data, and the ROI identification data includes the unique identifier of each of the one or more ROIs in the segmentation frame. In some embodiments, the ROI identification data includes, for each of the one or more ROIs, a respective ROI global identifier that uniquely identifies the ROI across multiple frames.

In some embodiments, the method 1900 includes combining the segmentation data, the encrypted media data, and the masked version of the input media data to generate combined media data. The combined media data may include or correspond to the combined output data 160. To combine the segmentation data, the encrypted media data, and the masked version of the input media data, the method 1900 can include concatenating together the segmentation data, the encrypted media data, and the masked version of the input media data to generate the combined media data. The method 1900 may include providing, to an encoder, the combined media data, one or more encoder settings, or a combination thereof. The encoder may include or correspond to the encoder 128, 928, or 1028.

In some embodiments, the method 1900 includes obtaining (e.g., generating or receiving) position data that indicates a position of the portion of the input media data that includes the instance of the object class. For example, the position data may include or correspond to the position data 452, such as one or more pixel coordinates. In some such embodiments, the output media data includes the position data. Additionally, or alternatively, the output media data may include an object class indicator, an identity indicator, or a combination thereof. For example, the object class indicator and the identity indicator may include or correspond to the object class indicator 461 and the identity indicator 407, respectively. The object class indicator may include or indicate the object class, a number of object classes, or a combination thereof. The identity indicator may include or indicate a device ID, a user ID of a user of the device, or a combination thereof.

In some embodiments, the method 1900 includes storing the output media data at a memory, such as the memory 106. Additionally, or alternatively, the method 1900 can include outputting, via a display device, display data based on the output media data. For example, the display device may include or correspond to the display device 916.

In some embodiments, the method 1900 includes sending the output media data to a decoder device. Additionally, or alternatively, the method 1900 can include transmitting, via a modem, the output media data to a decoder device. For example, the modem may include or correspond to the modem 918. The decoder device may include or correspond to the device 702 or the decoder 738, 938, or 1029.

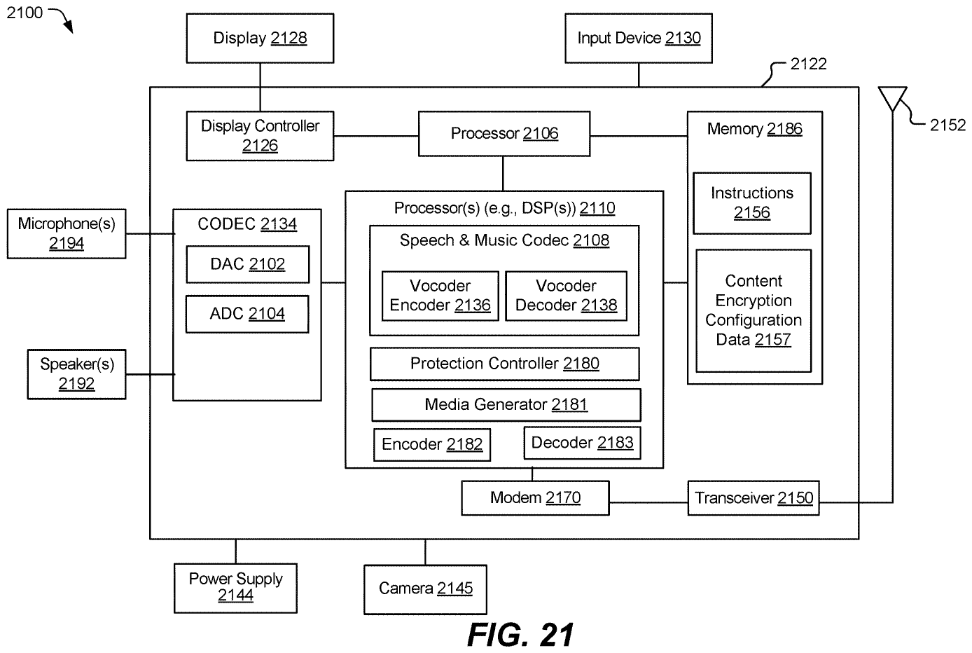

The method 1900 of FIG. 19 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1900 of FIG. 19 may be performed by a processor that executes instructions, such as described with reference to FIG. 21.

FIG. 20 is a diagram of an example of a method 2000 of decryption of media content, in accordance with some aspects of the present disclosure. In a particular aspect, one or more operations of the method 2000 are performed by the system 700, the device 702, the processor 108, the protection controller 110 or 710, the media generator 120 or 720, the decoder 738, the device 902, the protection controller 910, the media generator 920, the decoder 938, the integrated circuit 1000, the protection controller 1010, the media generator 1020, the decoder 1029, the mobile device 1100, the wearable electronic device 1200, the voice-controlled speaker system 1300, the camera device 1400, the headset 1500, the glasses 1600, the vehicle 1700 or 1800, or a combination thereof.

In some embodiments, the method 2000 includes, at block 2002, obtaining output media data associated with media data. The output media data may include or correspond to the masked image frame 144 or 244, the encrypted ROI content 148 or 532, the combined output data 160, the encoded output data 162, the content protection data 164, the encrypted ROI frame 248, the encoded masked image frame 414, the encoded encrypted ROI content 418, the encoded segmentation frame 455, the bitstream 499, the encrypted ROI frame 536, or the ROI segmentation frame 555. The media data may include or correspond to the image data 140 or the input image frame 142 or 242. The media data may include image data, audio data, or a combination thereof. In some examples, the media data represents an image frame. For example, the image frame may be associated with image data generated by one or more cameras, such as the image sensor 912.

In some embodiments, the output media data includes an encoded encrypted ROI frame (e.g., the encoded encrypted ROI frame 492) corresponding to encrypted ROI content (e.g., encrypted media data) associated with a region of interest (ROI) (e.g., a portion) of the media data that includes an instance of an object class, such as the object class 107. The encrypted ROI content may include or correspond to the encrypted ROI content 148, the encoded encrypted ROI content 418, the encrypted ROI frame 248 or 536, or the encoded encrypted ROI frame 492. In some examples, the encrypted ROI content is encrypted based on a key, such as the key 104, 137, or 736. The output media data further includes an encoded masked image frame (e.g., the encoded masked image frame 414 or the encoded masked image frame 474) corresponding to a masked version of the media data. The masked version may include a masked portion associated with the ROI (e.g., the portion) of the media data. For example, the masked version of the media data may include or correspond to the masked image frame 144 or 244, the encoded masked image frame 414, or the encoded masked image frame 474. The output media data further includes content protection data including an encryption indicator that indicates that the output media data includes the encrypted ROI content (e.g., the encrypted media data), such as the content protection data 164 that includes the encryption indicator 165. The encoded encrypted ROI frame is indicated as a non-display frame by a non-display indicator (e.g., the no display SEI 486 in the header 494 of the encoded encrypted ROI frame 492). Additionally, or alternatively, the output media data (e.g., the content protection data 164) can include or indicate an encryption type indicator, one or more encryption parameters, or a combination thereof.

In some embodiments, the output media data includes position data that indicates a position of the ROI (e.g., the portion) of the media data that includes the instance of the object class. For example, the position data may include or correspond to the position data 452, such as one or more pixel coordinates. Additionally, or alternatively, the output media data may include an object class indicator, an identity indicator, or a combination thereof. For example, the object class indicator and the identity indicator may include or correspond to the object class indicator 461 and the identity indicator 407, respectively.

In some embodiments, the output media data includes segmentation data that is based on the instance of the object class in the media data. For example, the segmentation data may include or correspond to the encoded segmentation frame 455, the ROI segmentation frame 555, or a combination thereof. In some such embodiments, the output media data includes the segmentation data. Additionally, the output media data may include a non-display indicator (e.g., the non-display indicator 431) associated with the segmentation data, and the non-display indicator causes the segmentation data to not be output for display.

In a particular example, the encoded segmentation frame 482 in the bitstream 499 includes the encoded pixel data 490 (e.g., encoded pixel data of the ROI segmentation frame 555), and the header 484 of the encoded segmentation frame 482 includes the no display SEI 486 associated with the segmentation data. In some examples, the frame header includes a flag that identifies the frame header as belonging to a segmentation frame, such as the ROI segmentation frame flag 485. In some examples, the frame header includes a display order frame identifier that corresponds to the masked image frame, such as the frame ID 487 in the header 484 that corresponds to the display order frame ID 478 of the encoded masked image frame 474. In some embodiments, the frame header includes ROI identification data associated with one or more ROIs in the segmentation frame, such as the ROI ID data 488. In an example, a unique identifier is assigned to each ROI in the media data, and the ROI identification data includes the unique identifier of each of the one or more ROIs in the segmentation frame.

In some embodiments, the method 2000 includes receiving, via an input device, an input and providing the input to a processor (e.g., the processor 108). For example, the input device and the input may include or correspond to the input device 914 and the input data 915, respectively. In some implementations, the input includes a request to output media content based on the output media data. Additionally, or alternatively, the method 2000 may include receiving, via a modem, the output media data from another device. For example, the modem may include or correspond to the modem 918.

At block 2004, the method 2000 includes identifying the encryption indicator. For example, the encryption indicator may be identified by the processor 108, the decoder 783, 938, 1029, the protection controller 710, 910, or 1010, or the parser/transformer 804.

At block 2006, the method 2000 further includes decrypting, based on identification of the encryption indicator, the encrypted ROI content (e.g., the encrypted media data) to obtain the ROI (e.g., the portion) of the media data. In some embodiments, the method 2000 includes determining a value of the encryption indicator, and selectively decrypting the encrypted ROI content based on the value of the encryption indicator. In a particular embodiment, the method 2000 includes selecting, based on the content protection data, a key (e.g., such as the key 104, 137, or 736) to decrypt the encrypted ROI content. In embodiments in which the content protection data includes one or more encryption parameters (e.g., the encryption parameters 472 in the sequence data 470 associated with a sequence of image frames, the encryption parameters 496 in the header 494 of the encoded encrypted ROI frame 492, or a combination thereof), decrypting the encrypted ROI content can be based on the one or more encryption parameters.

At block 2008, the method 2000 includes modifying the masked version of the media data to include the ROI (e.g., the portion) of the media data. The modified masked version of the media data that includes the ROI of the media data may include or correspond to the output image frame 740. In some embodiments, to modify the masked version of the media data to include the ROI of the media data, the method 2000 includes modifying the masked version of the media data to include the ROI of the media data based on the position data. Additionally, or alternatively, to modify the masked version of the media data to include the ROI of the media data, the method 2000 may include modifying the masked version of the media data to include the ROI of the media data based on the segmentation data. In a particular embodiment, inclusion of the ROI (e.g., the portion) of the media data into the masked media data results in unmasked media data. In some embodiments, the method 2000 includes storing the unmasked media data at a memory, such as the memory 106. Additionally, or alternatively, the method 2000 can include sending the unmasked media data to a display device. For example, the display device may include or correspond to the display device 916. The method 2000 may also include outputting, via the display device, the display data based on the unmasked media data.

The method 2000 of FIG. 20 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 2000 of FIG. 20 may be performed by a processor that executes instructions, such as described with reference to FIG. 21.

It is noted that one or more blocks (or operations) described with reference to FIGS. 19 and/or 20 may be combined with one or more blocks (or operations) described with reference to another of the figures. For example, one or more blocks (or operations) of FIGS. 19 and/or 20 may be combined with one or more blocks (or operations) of FIG. 1, 5, 7, 8A-8C, 9, or 10. As another example, one or more blocks associated with FIGS. 19 and/or 20 may be combined with one or more blocks (or operations) associated with FIGS. 1-18. Additionally, or alternatively, one or more operations described above with reference to FIGS. 1-20 may be combined with one or more operations described with reference to FIG. 21.

Referring to FIG. 21, FIG. 21 is a block diagram of an illustrative example of a device 2100 that is operable to identify and encrypt media content, in accordance with one or more aspects of the present disclosure. In various implementations, the device 2100 may have more or fewer components than illustrated in FIG. 21. In an illustrative implementation, the device 2100 may correspond to the device 102, 702, or 902. In an illustrative implementation, the device 2100 may perform one or more operations described with reference to FIGS. 1-20.

In a particular implementation, the device 2100 includes a processor 2106 (e.g., a central processing unit (CPU)). The device 2100 may include one or more additional processors 2110 (e.g., one or more DSPs). In a particular aspect, the processor 108 of FIG. 1 or the processor 1008 of FIG. 10 corresponds to the processor 2106, the processors 2110, or a combination thereof. The processors 2110 may include a speech and music coder-decoder (CODEC) 2108 that includes a voice coder (“vocoder”) encoder 2136, a vocoder decoder 2138, or a combination thereof. Additionally, or alternatively, the processors 2110 may include a protection controller 2180, a media generator 2181, an encoder 2182, a decoder 2183, or a combination thereof. The protection controller 2180 may include or correspond to the protection controller 110, 710, 910, or 1010. The media generator 2181 may include or correspond to the media generator 120, 720, 920, or 1020. The encoder 2182 may include or correspond to the encoder 128, 928, or 1028. The decoder 2183 may include or correspond to the decoder 738, 938, or 1029.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 2100 may include a memory 2186 and a CODEC 2134. The memory 2186 may include or correspond to the memory 106 or 1006. The memory 2186 may include instructions 2156, that are executable by the one or more additional processors 2110 (or the processor 2106) to implement the functionality described with reference to the protection controller 2180, the media generator 2181, the encoder 2182, the decoder 2183, or a combination thereof. The instructions 2156 may include or correspond to the instructions 109. The memory 2186 also may include content encryption configuration data 2157. The content encryption configuration data 2157 may include or correspond to the content encryption configuration 130. The device 2100 may include a modem 2170 coupled, via a transceiver 2150, to an antenna 2152. The modem 2170 may include or correspond to the modem 918.

The device 2100 may include a display 2128 coupled to a display controller 2126. One or more speakers 2192, one or more microphone(s) 2194, or both, may be coupled to the CODEC 2134. The microphone(s) 2194 may include or correspond to the input device 914. The CODEC 2134 may include a digital-to-analog converter (DAC) 2102, an analog-to-digital converter (ADC) 2104, or both. In a particular implementation, the CODEC 2134 may receive analog signals from the microphone(s) 2194, convert the analog signals to digital signals using the analog-to-digital converter 2104, and provide the digital signals to the speech and music codec 2108. The speech and music codec 2108 may process the digital signals, and the digital signals may further be processed by the protection controller 2180, the media generator 2181, the encoder 2182, the decoder 2183, or a combination thereof. In a particular implementation, the speech and music codec 2108 may provide digital signals to the CODEC 2134. The CODEC 2134 may convert the digital signals to analog signals using the digital-to-analog converter 2102 and may provide the analog signals to the speaker 2192. The speaker 2192 may include or correspond to the speaker 917.

In a particular implementation, the device 2100 may be included in a system-in-package or system-on-chip device 2122. In a particular implementation, the memory 2186, the processor 2106, the processors 2110, the display controller 2126, the CODEC 2134, and the modem 2170 are included in the system-in-package or system-on-chip device 2122. In a particular implementation, an input device 2130, a power supply 2144, and a camera 2145 are coupled to the system-in-package or the system-on-chip device 2122. For example, the input device 2130 and the camera 2145 may include or correspond to the input device 914 and the image sensor 912, respectively. In some examples, the input device 2130 may include or be associated with the display device 916 or the display 2128. Moreover, in a particular implementation, as illustrated in FIG. 21, the display 2128, the input device 2130, the speaker(s) 2192, the microphone(s) 2194, the antenna 2152, the power supply 2144, and the camera 2145 are external to the system-in-package or the system-on-chip device 2122. In a particular implementation, each of the display 2128, the input device 2130, the speaker(s) 2192, the microphone(s) 2194, the antenna 2152, the power supply 2144, and the camera 2145 may be coupled to a component of the system-in-package or the system-on-chip device 2122, such as an interface or a controller.

The device 2100 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, an earbud, a hearing aid, a car, a computing device, a communication device, an internet-of-things (IOT) device, a virtual reality (VR) device, a base station, a mobile device, or any combination thereof.

In conjunction with the described implementations, an apparatus includes means for obtaining input media data and identifying a portion of the input media data that includes an instance of an object class. For example, the means for obtaining and identifying can include the system 100 or 900, the device 102 or 902, the processor 108 or 1008, the media generator 120, 920, or 1020, the ROI identifier 121, the ROI detector 510, the modem 918, the image sensor 912, the integrated circuit 1000, the input interface 1004, the mobile device 1100, the wearable electronic device 1200, the voice-controlled speaker system 1300, the camera device 1400, the headset 1500, the glasses 1600, the vehicle 1700, the vehicle 1800, the processor 2106, the processor(s) 2110, the system-in-package or the system-on-chip device 2122, the device 2100, the antenna 2152, the transceiver 2150, the modem 2170, other circuitry configured to obtain input media data that includes an instance of an object class, or a combination thereof.

The apparatus also includes means for extracting and encrypting data from the portion of the input media data to generate encrypted media data. For example, the means for extracting and encrypting can include the system 100 or 900, the device 102 or 902, the processor 108 or 1008, the media generator 120, 920, or 1020, the ROI generator 123, the encryptor 124, the integrated circuit 1000, the mobile device 1100, the wearable electronic device 1200, the voice-controlled speaker system 1300, the camera device 1400, the headset 1500, the glasses 1600, the vehicle 1700, the vehicle 1800, the processor 2106, the processor(s) 2110, the system-in-package or the system-on-chip device 2122, the device 2100, other circuitry configured to encrypt the portion, or a combination thereof.

The apparatus further includes means for masking the portion of the input media data to generate a masked version of the input media data. For example, the means for masking can include the system 100 or 900, the device 102 or 902, the processor 108 or 1008, the media generator 120, 920, or 1020, the ROI masker 122, the integrated circuit 1000, the mobile device 1100, the wearable electronic device 1200, the voice-controlled speaker system 1300, the camera device 1400, the headset 1500, the glasses 1600, the vehicle 1700, the vehicle 1800, the processor 2106, the processor(s) 2110, the system-in-package or the system-on-chip device 2122, the device 2100, other circuitry configured to mask the portion, or a combination thereof.

The apparatus includes means for generating output media data that includes the masked version of the input media data, the encrypted media data, and content protection data, the content protection data including an encryption indicator that indicates the output media data includes the encrypted media data. For example, the means for generating can include the system 100 or 900, the device 102 or 902, the processor 108 or 1008, the media generator 120, 920, or 1020, the encoder 128, 928, 1028, or 2182, the integrated circuit 1000, the mobile device 1100, the wearable electronic device 1200, the voice-controlled speaker system 1300, the camera device 1400, the headset 1500, the glasses 1600, the vehicle 1700, the vehicle 1800, the processor 2106, the processor(s) 2110, the system-in-package or the system-on-chip device 2122, the device 2100, other circuitry configured to generate the output media data, or a combination thereof.

In conjunction with the described implementations, an apparatus includes means for obtaining output media data associated with media data. For example, the means for obtaining can include the system 700 or 900, the device 702 or 902, the processor 108 or 1008, the media generator 720, 920, 1020, or 2181, the decoder 738, 1029, or 2183, the modem 918, the integrated circuit 1000, the input interface 1004, the mobile device 1100, the wearable electronic device 1200, the voice-controlled speaker system 1300, the camera device 1400, the headset 1500, the glasses 1600, the vehicle 1700, the vehicle 1800, the processor 2106, the processor(s) 2110, the antenna 2152, the transceiver 2150, the modem 2170, the system-in-package or the system-on-chip device 2122, the device 2100, other circuitry configured to obtain the output media data, or a combination thereof. The output media data includes encrypted media data associated with a portion of the media data that includes an instance of an object class; a masked version of the media data, the masked version including a masked portion associated with the portion of the media data; and content protection data, the content protection data including an encryption indicator that indicates the output media data includes the encrypted data.

The apparatus also includes means for identifying the encryption indicator. For example, the means for identifying can include the system 700 or 900, the device 702 or 902, the processor 108 or 1008, the media generator 720, 920, 1020, or 2181, the decoder 738, 938, 1029, or 2183, the protection controller 710, 910, 1010, or 2180, the parser/transformer 804, the integrated circuit 1000, the mobile device 1100, the wearable electronic device 1200, the voice-controlled speaker system 1300, the camera device 1400, the headset 1500, the glasses 1600, the vehicle 1700, the vehicle 1800, the processor 2106, the processor(s) 2110, the system-in-package or the system-on-chip device 2122, the device 2100, other circuitry configured to identify the encryption indicator, or a combination thereof.

The apparatus further includes means for decrypting, based on identification of the encryption indicator, the encrypted media data to obtain the portion of the media data. For example, the means for decrypting can include the system 700 or 900, the device 702 or 902, the processor 108 or 1008, the media generator 720, 920, 1020, or 2181, the output generator 722, the decryptor 724, the integrated circuit 1000, the mobile device 1100, the wearable electronic device 1200, the voice-controlled speaker system 1300, the camera device 1400, the headset 1500, the glasses 1600, the vehicle 1700, the vehicle 1800, the processor 2106, the processor(s) 2110, the system-in-package or the system-on-chip device 2122, the device 2100, other circuitry configured to decrypt the encrypted media data, or a combination thereof.

The apparatus includes means for modifying the masked version of the media data to include the portion of the media data. For example, the means for modifying can include the system 700 or 900, the device 702 or 902, the processor 108 or 1008, the media generator 720, 920, 1020, or 2181, the output generator 722, the ROI positioner 886, the integrated circuit 1000, the mobile device 1100, the wearable electronic device 1200, the voice-controlled speaker system 1300, the camera device 1400, the headset 1500, the glasses 1600, the vehicle 1700, the vehicle 1800, the processor 2106, the processor(s) 2110, the system-in-package or the system-on-chip device 2122, the device 2100, other circuitry configured to modify the masked version, or a combination thereof.

In some implementations, a non-transitory computer-readable medium (e.g., a computer-readable storage device, such as the memory 2186) includes instructions (e.g., the instructions 2156) that, when executed by one or more processors (e.g., the one or more processors 2110 or the processor 2106), cause the one or more processors to obtain input media data and identify a portion of the input media data that includes an instance of an object class. The instructions further cause the one or more processors to extract and encrypt data from the portion of the input media data to generate encrypted media data. The instructions further cause the one or more processors to mask the portion of the input media data to generate a masked version of the input media data. The instructions further cause the one or more processors to generate output media data that includes the masked version of the input media data, the encrypted media data, and content protection data, the content protection data including an encryption indicator that indicates the output media data includes the encrypted media data.

In some implementations, a non-transitory computer-readable medium (e.g., a computer-readable storage device, such as the memory 2186) includes instructions (e.g., the instructions 2156) that, when executed by one or more processors (e.g., the one or more processors 2110 or the processor 2106), cause the one or more processors to obtain output media data associated with media data. The output media data includes encrypted media data associated with a portion of the media data that includes an instance of an object class; a masked version of the media data, the masked version includes a masked portion associated with the portion of the media data; and content protection data, the content protection data includes an encryption indicator that indicates the output media data includes the encrypted media data. The instructions further cause the one or more processors to identify the encryption indicator. The instructions also cause the one or more processors, based on identification of the encryption indicator, to decrypt the encrypted media data to obtain the portion of the media data, and modify the masked version of the media data to include the portion of the media data.

Particular aspects of the disclosure are described below in sets of interrelated Examples:

According to Example 1, a device includes one or more processors configured to: obtain input media data including an instance of an object class; identify a region of interest (ROI) corresponding to the instance of the object class; extract and encrypt ROI content from the ROI to generate encrypted ROI content; mask at least a portion of the ROI to generate a masked image frame; and generate output media data that includes: an encoded masked image frame corresponding to the masked image frame; an encoded encrypted ROI frame corresponding to the encrypted ROI content; and content protection data, the content protection data including an encryption indicator that indicates the output media data includes the encrypted ROI content, wherein the encoded encrypted ROI frame is indicated as a non-display frame by a non-display indicator.

Example 2 includes the device of Example 1, wherein the ROI corresponds to a portion of the input media data that includes the instance of the object class, wherein the encrypted ROI content includes encrypted media data, wherein the masked image frame includes a masked version of the input media data, and wherein the output media data includes the masked version of the input media data and the encrypted media data.

Example 3 includes the device of Example 1 or Example 2, wherein the output media data further includes an encoded segmentation frame corresponding to segmentation data indicating the ROI, and wherein the encoded segmentation frame is indicated as a non-display frame by the non-display indicator.

Example 4 includes the device of any of Examples 1 to 3, wherein the output media data includes a bitstream, and wherein the content protection data is included in metadata of the bitstream, one or more frame headers in the bitstream, or a combination thereof.

Example 5 includes the device of Example 3 or Example 4, wherein the non-display indicator comprises a no-display supplemental enhancement information (SEI) message included in a frame header of at least one of the encoded segmentation frame or the encoded encrypted ROI frame.

Example 6 includes the device of any of Examples 3 to 5, wherein the encoded masked image frame includes a first frame header including a display-order frame identifier; and each of (i) the encoded segmentation frame and (ii) the encoded encrypted ROI frame includes a corresponding frame identifier that associates the encoded segmentation frame and the encoded encrypted ROI frame with the encoded masked image frame.

Example 7 includes the device of any of Examples 3 to 6, wherein the encoded segmentation frame includes a segmentation-frame flag indicating that the encoded segmentation frame corresponds to ROI segmentation data.

Example 8 includes the device of any of Examples 1 to 7, wherein the output media data includes: a sequence of image frames; and sequence data associated with the sequence of image frames, wherein the sequence data includes the encryption indicator.

Example 9 includes the device of Example 8, wherein the sequence data includes one or more encryption parameters associated with the sequence of image frames.

Example 10 includes the device of Example 9, wherein the one or more encryption parameters include an encryption algorithm identifier, an encryption mode, a total encryption parameter size, one or more encryption algorithm parameter values, or a combination thereof.

Example 11 includes the device of Example 9 or Example 10, wherein the one or more encryption parameters include an alphabet size, a maximum block size, an input data bit-width, a public key certificate, a certificate authority, a digital signature, or a combination thereof.

Example 12 includes the device of any of Examples 8 to 11, wherein the output media data includes a masked image frame that includes the masked image frame and a frame header that includes a display order frame identifier that indicates a display order of the masked image frame in the sequence.

Example 13 includes the device of any of Examples 1 to 12, wherein the encoded encrypted ROI frame includes an encrypted-ROI-frame flag indicating that the encoded encrypted ROI frame corresponds to encrypted ROI content.

Example 14 includes the device of any of Examples 1 to 13, wherein the output media data includes a non-display indicator associated with the encrypted ROI content.

Example 15 includes the device of Example 14, wherein the output media data includes an encrypted region of interest (ROI) frame that includes the encrypted ROI content and a frame header that includes the non-display indicator associated with the encrypted ROI content.

Example 16 includes the device of Example 15, wherein the frame header includes a flag that identifies the frame header as belonging to an encrypted ROI frame.

Example 17 includes the device of Example 15 or Example 16, wherein the output media data includes a masked image frame that includes the masked image frame, and wherein the frame header includes a display order frame identifier that corresponds to the masked image frame.

Example 18 includes the device of any of Examples 15 to 17, wherein the frame header includes encryption parameters associated with one or more encrypted ROIs in the encrypted ROI frame.

Example 19 includes the device of any of Examples 1 to 18, wherein: the one or more processors are configured to generate segmentation data based on the instance of the object class in the input media data; and the output media data includes the segmentation data.

Example 20 includes the device of Example 19, wherein the output media data includes a non-display indicator associated with the segmentation data.

Example 21 includes the device of Example 20, wherein the output media data includes a segmentation frame that includes the segmentation data and a frame header that includes the non-display indicator associated with the segmentation data.

Example 22 includes the device of Example 21, wherein the frame header includes a flag that identifies the frame header as belonging to a segmentation frame.

Example 23 includes the device of Example 22, wherein the output media data includes a masked image frame that includes the masked image frame, and wherein the frame header includes a display order frame identifier that corresponds to the masked image frame.

Example 24 includes the device of any of Examples 21 to 23, wherein the frame header includes ROI identification data associated with one or more ROIs in the segmentation frame.

Example 25 includes the device of Example 24, wherein a unique identifier is assigned to each ROI in the input media data, and wherein the ROI identification data includes the unique identifier of each of the one or more ROIs in the segmentation frame.

Example 26 includes the device of Example 24 or Example 25, wherein the ROI identification data includes, for each of the one or more ROIs, a respective ROI global identifier.

Example 27 includes the device of any of Examples 19 to 26, wherein the one or more processors are configured to: combine the segmentation data, the encrypted ROI content, and the masked image frame to generate combined media data; and provide, to an encoder, the combined media data, one or more encoder settings, or a combination thereof, to generate the output media data.

Example 28 includes the device of any of Examples 1 to 27, wherein: the one or more processors are configured to generate position data that indicates a position of the ROI that includes the instance of the object class; and the output media data includes the position data.

Example 29 includes the device of any of Examples 1 to 28, wherein the content protection data further includes encryption parameters indicating at least one of an encryption algorithm identifier, an encryption mode, or one or more encryption algorithm parameter values associated with encrypting the ROI content, and wherein the encryption parameters include cipher text corresponding to an encrypted secret key for decrypting the encrypted ROI content.

Example 30 includes the device of any of Examples 1 to 29, wherein: the one or more processors are configured to decrypt the encrypted ROI content to obtain decrypted ROI content; and modify the masked image frame to include the decrypted ROI content based on at least one of segmentation data or position data associated with the ROI.

Example 31 includes the device of any of Examples 1 to 30, wherein the output media data is compliant with a video coding standard and is configured such that a decoder not aware of encryption ignores the encoded encrypted ROI frame based on the non-display indicator.

Example 32 includes the device of any of Examples 1 to 31 and further includes a memory coupled to the one or more processors and configured to store a content encryption configuration that indicates the object class, and wherein the one or more processors are configured to detect the instance of the object class in the input media data.

Example 33 includes the device of Example 32, wherein the one or more processors are configured to store the output media data at the memory.

Example 34 includes the device of any of Examples 1 to 33, wherein the one or more processors are configured to send the output media data to a decoder device.

Example 35 includes the device of any of Examples 1 to 34 and further includes one or more cameras coupled to the one or more processors, and wherein the one or more cameras are configured to generate the input media data.

Example 36 includes the device of any of Examples 1 to 35 and further includes a display device coupled to the one or more processors and configured to output display data based on the output media data.

Example 37 includes the device of any of Examples 1 to 36 and further includes a modem coupled to the one or more processors, the modem configured to transmit the output media data to a decoder device.

Example 38 includes the device of any of Examples 1 to 37 and further includes an input device configured to receive an input and provide the input to the one or more processors, wherein the input includes a request to generate the input media data.

Example 39 includes the device of any of Examples 1 to 38, wherein the one or more processors are integrated in a mobile phone, a tablet computer device, a wearable electronic device, a virtual reality headset, a mixed reality headset, an augmented reality headset, or a camera device.

Example 40 includes the device of any of Examples 1 to 38, wherein the one or more processors are integrated in a vehicle.

According to Example 41, a method includes: obtaining, at a device, input media data including an instance of an object class; identifying, at the device, a region of interest (ROI) corresponding to the instance of the object class; extracting and encrypting, at the device, ROI content from the ROI to generate encrypted ROI content; masking, at the device, at least a portion of the ROI to generate a masked image frame; and generating, at the device, output media data that includes: an encoded masked image frame corresponding to the masked image frame; an encoded encrypted ROI frame corresponding to the encrypted ROI content; and content protection data, the content protection data including an encryption indicator that indicates the output media data includes the encrypted ROI content, wherein the encoded encrypted ROI frame is indicated as a non-display frame by a non-display indicator.

Example 42 includes the method of Example 41, wherein the ROI corresponds to a portion of the input media data that includes the instance of the object class, wherein the encrypted ROI content includes encrypted media data, wherein the masked image frame includes a masked version of the input media data, and wherein the output media data includes the masked version of the input media data and the encrypted media data.

Example 43 includes the method of Example 41 or Example 42, wherein the output media data further includes an encoded segmentation frame corresponding to segmentation data indicating the ROI, and wherein the encoded segmentation frame is indicated as a non-display frame by the non-display indicator.

Example 44 includes the method of any of Examples 41 to 43, wherein the output media data includes a bitstream, and wherein the content protection data is included in metadata of the bitstream, one or more frame headers in the bitstream, or a combination thereof.

Example 45 includes the method of Example 43 or Example 44, wherein the non-display indicator comprises a no-display supplemental enhancement information (SEI) message included in a frame header of at least one of the encoded segmentation frame or the encoded encrypted ROI frame.

Example 46 includes the method of any of Examples 43 to 45, wherein the encoded masked image frame includes a first frame header including a display-order frame identifier; and each of (i) the encoded segmentation frame and (ii) the encoded encrypted ROI frame includes a corresponding frame identifier that associates the encoded segmentation frame and the encoded encrypted ROI frame with the encoded masked image frame.

Example 47 includes the method of any of Examples 43 to 46, wherein the encoded segmentation frame includes a segmentation-frame flag indicating that the encoded segmentation frame corresponds to ROI segmentation data.

Example 48 includes the method of any of Examples 41 to 47, wherein the output media data includes: a sequence of image frames; and sequence data associated with the sequence of image frames, wherein the sequence data includes the encryption indicator.

Example 49 includes the method of Example 48, wherein the sequence data includes one or more encryption parameters associated with the sequence of image frames.

Example 50 includes the method of Example 49, wherein the one or more encryption parameters include an encryption algorithm identifier, an encryption mode, a total encryption parameter size, one or more encryption algorithm parameter values, or a combination thereof.

Example 51 includes the method of Example 49 or Example 50, wherein the one or more encryption parameters include an alphabet size, a maximum block size, an input data bit-width, a public key certificate, a certificate authority, a digital signature, or a combination thereof.

Example 52 includes the method of any of Examples 48 to 51, wherein the output media data includes a masked image frame that includes the masked image frame and a frame header that includes a display order frame identifier that indicates a display order of the masked image frame in the sequence.

Example 53 includes the method of any of Examples 41 to 52, wherein the encoded encrypted ROI frame includes an encrypted-ROI-frame flag indicating that the encoded encrypted ROI frame corresponds to encrypted ROI content.

Example 54 includes the method of any of Examples 41 to 53, wherein the output media data includes a non-display indicator associated with the encrypted ROI content.

Example 55 includes the method of Example 54, wherein the output media data includes an encrypted region of interest (ROI) frame that includes the encrypted ROI content and a frame header that includes the non-display indicator associated with the encrypted ROI content.

Example 56 includes the method of Example 55, wherein the frame header includes a flag that identifies the frame header as belonging to an encrypted ROI frame.

Example 57 includes the method of Example 55 or Example 56, wherein the output media data includes a masked image frame that includes the masked image frame, and wherein the frame header includes a display order frame identifier that corresponds to the masked image frame.

Example 58 includes the method of any of Examples 55 to 57, wherein the frame header includes encryption parameters associated with one or more encrypted ROIs in the encrypted ROI frame.

Example 59 includes the method of any of Examples 41 to 58 and further includes generating segmentation data based on the instance of the object class in the input media data, and wherein the output media data includes the segmentation data.

Example 60 includes the method of Example 59, wherein the output media data includes a non-display indicator associated with the segmentation data.

Example 61 includes the method of Example 60, wherein the output media data includes a segmentation frame that includes the segmentation data and a frame header that includes the non-display indicator associated with the segmentation data.

Example 62 includes the method of Example 61, wherein the frame header includes a flag that identifies the frame header as belonging to a segmentation frame.

Example 63 includes the method of Example 62, wherein the output media data includes a masked image frame that includes the masked image frame, and wherein the frame header includes a display order frame identifier that corresponds to the masked image frame.

Example 64 includes the method of any of Examples 61 to 63, wherein the frame header includes ROI identification data associated with one or more ROIs in the segmentation frame.

Example 65 includes the method of Example 64, wherein a unique identifier is assigned to each ROI in the input media data, and wherein the ROI identification data includes the unique identifier of each of the one or more ROIs in the segmentation frame.

Example 66 includes the method of Example 64 or Example 65, wherein the ROI identification data includes, for each of the one or more ROIs, a respective ROI global identifier.

Example 67 includes the method of any of Examples 59 to 66 and further includes combining the segmentation data, the encrypted ROI content, and the masked image frame to generate combined media data; and providing, to an encoder, the combined media data, one or more encoder settings, or a combination thereof, to generate the output media data.

Example 68 includes the method of any of Examples 41 to 67 and further includes generating position data that indicates a position of the ROI that includes the instance of the object class; and wherein the output media data includes the position data.

Example 69 includes the method of any of Examples 41 to 68, wherein the content protection data further includes encryption parameters indicating at least one of an encryption algorithm identifier, an encryption mode, or one or more encryption algorithm parameter values associated with encrypting the ROI content, and wherein the encryption parameters include cipher text corresponding to an encrypted secret key for decrypting the encrypted ROI content.

Example 70 includes the method of any of Examples 41 to 69 and further includes decrypting the encrypted ROI content to obtain decrypted ROI content; and modifying the masked image frame to include the decrypted ROI content based on at least one of segmentation data or position data associated with the ROI.

Example 71 includes the method of any of Examples 41 to 70, wherein the output media data is compliant with a video coding standard and is configured such that a decoder not aware of encryption ignores the encoded encrypted ROI frame based on the non-display indicator.

Example 72 includes the method of any of Examples 41 to 71 and further includes accessing, from a memory, a content encryption configuration that indicates the object class, and detecting the instance of the object class in the input media data.

Example 73 includes the method of Example 72 and further includes storing the output media data at the memory.

Example 74 includes the method of any of Examples 41 to 73 and further includes sending the output media data to a decoder device.

Example 75 includes the method of any of Examples 41 to 74 and further includes generating the input media data at one or more cameras.

Example 76 includes the method of any of Examples 41 to 75 and further includes outputting, at a display device, display data based on the output media data.

Example 77 includes the method of any of Examples 41 to 76 and further includes transmitting the output media data to a decoder device.

Example 78 includes the method of any of Examples 41 to 77 and further includes receiving, at an input device, an input that includes a request to generate the input media data.

Example 79 includes the method of any of Examples 41 to 78, performed by a mobile phone, a tablet computer device, a wearable electronic device, a virtual reality headset, a mixed reality headset, an augmented reality headset, or a camera device.

Example 80 includes the method of any of Examples 41 to 78, performed by a vehicle.

According to Example 81, a device includes a memory configured to store instructions; and a processor configured to execute the instructions to perform the method of any of Examples 41 to 80.

According to Example 82, a non-transitory computer readable storage medium stores instructions that, when executed by a processor, cause the processor to perform the method of any of Examples 41 to 80.

According to Example 83, an apparatus includes means for carrying out the method of any of Examples 41 to 80.

According to Example 84, a non-transitory computer-readable medium stores instructions that are executable by one or more processors to cause the one or more processors to: obtain input media data including an instance of an object class; identify a region of interest (ROI) corresponding to the instance of the object class; extract and encrypt ROI content from the ROI to generate encrypted ROI content; mask at least a portion of the ROI to generate a masked image frame; and generate output media data that includes: an encoded masked image frame corresponding to the masked image frame; an encoded encrypted ROI frame corresponding to the encrypted ROI content; and content protection data, the content protection data including an encryption indicator that indicates the output media data includes the encrypted ROI content, wherein the encoded encrypted ROI frame is indicated as a non-display frame by a non-display indicator.

According to Example 85, an apparatus includes: means for obtaining input media data including an instance of an object class and identifying a region of interest (ROI) corresponding to the instance of the object class; means for extracting and encrypting ROI content from the ROI to generate encrypted ROI content; means for masking at least a portion of the ROI to generate a masked image frame; and means for generating output media data that includes: an encoded masked image frame corresponding to the masked image frame; an encoded encrypted ROI frame corresponding to the encrypted ROI content; and content protection data, the content protection data including an encryption indicator that indicates the output media data includes the encrypted ROI content, wherein the encoded encrypted ROI frame is indicated as a non-display frame by a non-display indicator.

According to Example 86, a device includes one or more processors configured to: obtain output media data associated with media data, the output media data including: an encoded encrypted ROI frame corresponding to encrypted ROI content associated with a region of interest (ROI) of the media data that includes an instance of an object class; an encoded masked image frame corresponding to a masked version of the media data; and content protection data, the content protection data including an encryption indicator that indicates the output media data includes the encrypted ROI content; identify the encryption indicator; and based on identification of the encryption indicator: decrypt the encrypted ROI content to obtain the ROI of the media data; and modify the masked version of the media data to include the ROI of the media data, wherein the encoded encrypted ROI frame is indicated as a non-display frame by a non-display indicator.

Example 87 includes the device of Example 86, wherein the encrypted ROI content includes encrypted media data associated with a portion of the media data that includes the instance of the object class, wherein the masked version of the media data includes a masked portion associated with the portion of the media data, and wherein the one or more processors are configured to decrypt the encrypted media data to obtain the portion of the media data and modify the masked version of the media data to include the portion of the media data.

Example 88 includes the device of Example 86 or Example 87, wherein the output media data includes a bitstream, and wherein the content protection data is included in metadata of the bitstream, one or more frame headers in the bitstream, or a combination thereof.

Example 89 includes the device of any of Examples 86 to 88, wherein the output media data includes: a sequence of image frames; and sequence data associated with the sequence of image frames, wherein the sequence data includes the encryption indicator.

Example 90 includes the device of Example 89, wherein the sequence data includes one or more encryption parameters associated with the sequence of image frames, and wherein the one or more processors are configured to decrypt the encrypted ROI content based on the one or more encryption parameters.

Example 91 includes the device of Example 90, wherein the one or more encryption parameters include an encryption algorithm identifier, an encryption mode, a total encryption parameter size, one or more encryption algorithm parameter values, or a combination thereof.

Example 92 includes the device of Example 90 or Example 91, wherein the one or more encryption parameters include an alphabet size, a maximum block size, an input data bit-width, a public key certificate, a certificate authority, a digital signature, or a combination thereof.

Example 93 includes the device of any of Examples 89 to 92, wherein the output media data includes a masked image frame that includes the masked version of the media data and a frame header that includes a display order frame identifier that indicates a display order of the masked image frame in the sequence.

Example 94 includes the device of any of Examples 86 to 93, wherein the output media data includes a non-display indicator associated with the encrypted ROI content, and wherein the non-display indicator causes the one or more processors to not output the encrypted ROI content for display.

Example 95 includes the device of Example 94, wherein the output media data includes an encrypted region of interest (ROI) frame that includes the encrypted ROI content and a frame header that includes the non-display indicator associated with the encrypted ROI content.

Example 96 includes the device of Example 95, wherein the frame header includes a flag that identifies the frame header as belonging to an encrypted ROI frame.

Example 97 includes the device of Example 95 or Example 96, wherein the output media data includes a masked image frame that includes the masked version of the media data, and wherein the frame header includes a display order frame identifier that corresponds to the masked image frame.

Example 98 includes the device of any of Examples 95 to 97, wherein the frame header includes encryption parameters associated with one or more encrypted ROIs in the encrypted ROI frame, and wherein the one or more processors are configured to decrypt the one or more encrypted ROIs in the encrypted ROI frame based on the encryption parameters.

Example 99 includes the device of any of Examples 86 to 98, wherein: the output media data includes segmentation data that is based on the instance of the object class in the media data; and the one or more processors are configured to modify the masked version of the media data to include the ROI of the media data based on the segmentation data.

Example 100 includes the device of Example 99, wherein the output media data includes a non-display indicator associated with the segmentation data, and wherein the non-display indicator causes the one or more processors to not output the segmentation data for display.

Example 101 includes the device of Example 100, wherein the output media data includes a segmentation frame that includes the segmentation data and a frame header that includes the non-display indicator associated with the segmentation data.

Example 102 includes the device of Example 101, wherein the frame header includes a flag that identifies the frame header as belonging to a segmentation frame.

Example 103 includes the device of Example 102, wherein the output media data includes a masked image frame that includes the masked version of the media data, and wherein the frame header includes a display order frame identifier that corresponds to the masked image frame.

Example 104 includes the device of any of Examples 101 to 103, wherein the frame header includes ROI identification data associated with one or more ROIs in the segmentation frame.

Example 105 includes the device of Example 104, wherein a unique identifier is assigned to each ROI in the media data, and wherein the ROI identification data includes the unique identifier of each of the one or more ROIs in the segmentation frame.

Example 106 includes the device of Example 104 or Example 105, wherein the ROI identification data includes, for each of the one or more ROIs, a respective ROI global identifier.

Example 107 includes the device of any of Examples 86 to 106, wherein the output media data includes position data that indicates a position of the ROI of the media data that includes the instance of the object class.

Example 108 includes the device of Example 107, wherein, to modify the masked version of the media data to include the ROI of the media data, the one or more processors are configured to modify the masked version of the media data to include the ROI of the media data based on the position data.

Example 109 includes the device of any of Examples 86 to 108 and further includes a memory coupled to the one or more processors and configured to store one or more keys, and wherein the one or more processors are configured to select, based on the content protection data, a key of the one or more keys to decrypt the encrypted ROI content.

Example 110 includes the device of any of Examples 86 to 109 and further includes a memory coupled to the one or more processors, wherein inclusion of the ROI of the media data into the masked version of the media data results in unmasked media data, and wherein the one or more processors are configured to store the unmasked media data to the memory.

Example 111 includes the device of any of Examples 86 to 110, wherein inclusion of the ROI of the media data into the masked version of the media data results in unmasked media data, and wherein the one or more processors are configured to send the unmasked media data to a display device.

Example 112 includes the device of any of Examples 86 to 111 and further includes a display device coupled to the one or more processors and configured to output display data based on the output media data.

Example 113 includes the device of any of Examples 86 to 112 and further includes a modem coupled to the one or more processors, the modem configured to receive the output media data from another device.

Example 114 includes the device of any of Examples 86 to 113 and further includes an input device configured to receive an input and provide the input to the one or more processors, wherein the input includes a request to output media content based on the output media data.

Example 115 includes the device of any of Examples 86 to 114, wherein the output media data is compliant with a video coding standard and is configured such that a decoder not aware of encryption ignores the encoded encrypted ROI frame based on the non-display indicator.

Example 116 includes the device of any of Examples 86 to 115, wherein the content protection data further includes encryption parameters indicating at least one of an encryption algorithm identifier, an encryption mode, or one or more encryption algorithm parameter values associated with the encrypted ROI content, and wherein the encryption parameters include cipher text corresponding to an encrypted secret key for decrypting the encrypted ROI content.

Example 117 includes the device of any of Examples 86 to 116, wherein the encoded encrypted ROI frame includes an encrypted-ROI-frame flag indicating that the encoded encrypted ROI frame corresponds to encrypted ROI content.

Example 118 includes the device of any of Examples 86 to 117, wherein the non-display indicator comprises a no-display supplemental enhancement information (SEI) message included in a frame header of the encoded encrypted ROI frame.

Example 119 includes the device of any of Examples 86 to 118, wherein the one or more processors are integrated in a mobile phone, a tablet computer device, a wearable electronic device, a virtual reality headset, a mixed reality headset, an augmented reality headset, or a camera device.

Example 120 includes the device of any of Examples 86 to 118, wherein the one or more processors are integrated in a vehicle.

According to Example 121, a method includes: obtaining, at a device, output media data associated with media data, the output media data including: an encoded encrypted ROI frame corresponding to encrypted ROI content associated with a region of interest (ROI) of the media data that includes an instance of an object class; an encoded masked image frame corresponding to a masked version of the media data; and content protection data, the content protection data including an encryption indicator that indicates the output media data includes the encrypted ROI content; identifying, at the device, the encryption indicator; decrypting, at the device and based on identification of the encryption indicator, the encrypted ROI content to obtain the ROI of the media data; and modifying, at the device and based on identification of the encryption indicator, the masked version of the media data to include the ROI of the media data, wherein the encoded encrypted ROI frame is indicated as a non-display frame by a non-display indicator.

Example 122 includes the method of Example 121, wherein the encrypted ROI content includes encrypted media data associated with a portion of the media data that includes the instance of the object class, wherein the masked version of the media data includes a masked portion associated with the portion of the media data, and wherein decrypting includes decrypting the encrypted media data to obtain the portion of the media data and modifying includes modifying the masked version of the media data to include the portion of the media data.

Example 123 includes the method of Example 121 or Example 122, wherein the output media data includes a bitstream, and wherein the content protection data is included in metadata of the bitstream, one or more frame headers in the bitstream, or a combination thereof.

Example 124 includes the method of any of Examples 121 to 123, wherein the output media data includes: a sequence of image frames; and sequence data associated with the sequence of image frames, wherein the sequence data includes the encryption indicator.

Example 125 includes the method of Example 124, wherein the sequence data includes one or more encryption parameters associated with the sequence of image frames, and wherein the method further includes decrypting the encrypted ROI content based on the one or more encryption parameters.

Example 126 includes the method of Example 125, wherein the one or more encryption parameters include an encryption algorithm identifier, an encryption mode, a total encryption parameter size, one or more encryption algorithm parameter values, or a combination thereof.

Example 127 includes the method of Example 125 or Example 126, wherein the one or more encryption parameters include an alphabet size, a maximum block size, an input data bit-width, a public key certificate, a certificate authority, a digital signature, or a combination thereof.

Example 128 includes the method of any of Examples 124 to 127, wherein the output media data includes a masked image frame that includes the masked version of the media data and a frame header that includes a display order frame identifier that indicates a display order of the masked image frame in the sequence.

Example 129 includes the method of any of Examples 121 to 128, wherein the output media data includes a non-display indicator associated with the encrypted ROI content, and wherein the non-display indicator causes the encrypted ROI content to not be output for display.

Example 130 includes the method of Example 129, wherein the output media data includes an encrypted region of interest (ROI) frame that includes the encrypted ROI content and a frame header that includes the non-display indicator associated with the encrypted ROI content.

Example 131 includes the method of Example 130, wherein the frame header includes a flag that identifies the frame header as belonging to an encrypted ROI frame.

Example 132 includes the method of Example 130 or Example 131, wherein the output media data includes a masked image frame that includes the masked version of the media data, and wherein the frame header includes a display order frame identifier that corresponds to the masked image frame.

Example 133 includes the method of any of Examples 130 to 132, wherein the frame header includes encryption parameters associated with one or more encrypted ROIs in the encrypted ROI frame, and wherein the method further includes decrypting the one or more encrypted ROIs in the encrypted ROI frame based on the encryption parameters.

Example 134 includes the method of any of Examples 121 to 133, wherein: the output media data includes segmentation data that is based on the instance of the object class in the media data; and modifying the masked version of the media data to include the ROI of the media data is based on the segmentation data.

Example 135 includes the method of Example 134, wherein the output media data includes a non-display indicator associated with the segmentation data, and wherein the non-display indicator causes the segmentation data to not be output for display.

Example 136 includes the method of Example 135, wherein the output media data includes a segmentation frame that includes the segmentation data and a frame header that includes the non-display indicator associated with the segmentation data.

Example 137 includes the method of Example 136, wherein the frame header includes a flag that identifies the frame header as belonging to a segmentation frame.

Example 138 includes the method of Example 137, wherein the output media data includes a masked image frame that includes the masked version of the media data, and wherein the frame header includes a display order frame identifier that corresponds to the masked image frame.

Example 139 includes the method of any of Examples 136 to 138, wherein the frame header includes ROI identification data associated with one or more ROIs in the segmentation frame.

Example 140 includes the method of Example 139, wherein a unique identifier is assigned to each ROI in the media data, and wherein the ROI identification data includes the unique identifier of each of the one or more ROIs in the segmentation frame.

Example 141 includes the method of Example 139 or Example 140, wherein the ROI identification data includes, for each of the one or more ROIs, a respective ROI global identifier.

Example 142 includes the method of any of Examples 121 to 141, wherein the output media data includes position data that indicates a position of the ROI of the media data that includes the instance of the object class.

Example 143 includes the method of Example 142 and further includes modifying the masked version of the media data to include the ROI of the media data based on the position data.

Example 144 includes the method of any of Examples 121 to 143 and further includes storing one or more keys to a memory, and selecting, based on the content protection data, a key of the one or more keys to decrypt the encrypted ROI content.

Example 145 includes the method of any of Examples 121 to 144, wherein inclusion of the ROI of the media data into the masked version of the media data results in unmasked media data, and wherein the method further includes storing the unmasked media data to a memory.

Example 146 includes the method of any of Examples 121 to 145, wherein inclusion of the ROI of the media data into the masked version of the media data results in unmasked media data, and wherein the method further includes sending the unmasked media data to a display device.

Example 147 includes the method of any of Examples 121 to 146 and further includes outputting, to a display device, display data based on the output media data.

Example 148 includes the method of any of Examples 121 to 147 and further includes receiving the output media data from another device.

Example 149 includes the method of any of Examples 121 to 148 and further includes receiving an input that includes a request to output media content based on the output media data.

Example 150 includes the method of any of Examples 121 to 149, wherein the output media data is compliant with a video coding standard and is configured such that a decoder not aware of encryption ignores the encoded encrypted ROI frame based on the non-display indicator.

Example 151 includes the method of any of Examples 121 to 150, wherein the content protection data further includes encryption parameters indicating at least one of an encryption algorithm identifier, an encryption mode, or one or more encryption algorithm parameter values associated with the encrypted ROI content, and wherein the encryption parameters include cipher text corresponding to an encrypted secret key for decrypting the encrypted ROI content.

Example 152 includes the method of any of Examples 121 to 151, wherein the encoded encrypted ROI frame includes an encrypted-ROI-frame flag indicating that the encoded encrypted ROI frame corresponds to encrypted ROI content.

Example 153 includes the method of any of Examples 121 to 152, wherein the non-display indicator comprises a no-display supplemental enhancement information (SEI) message included in a frame header of the encoded encrypted ROI frame.

Example 154 includes the method of any of Examples 121 to 153, performed by a mobile phone, a tablet computer device, a wearable electronic device, a virtual reality headset, a mixed reality headset, an augmented reality headset, or a camera device.

Example 155 includes the method of any of Examples 121 to 153, performed by a vehicle.

According to Example 156, a device includes a memory configured to store instructions; and a processor configured to execute the instructions to perform the method of any of Examples 121 to 155.

According to Example 157, a non-transitory computer readable storage medium stores instructions that, when executed by a processor, cause the processor to perform the method of any of Examples 121 to 155.

According to Example 158, an apparatus includes means for carrying out the method of any of Examples 121 to 155.

According to Example 159, a non-transitory computer-readable medium stores instructions that are executable by one or more processors to cause the one or more processors to: obtain output media data associated with media data, the output media data including: an encoded encrypted ROI frame corresponding to encrypted ROI content associated with a region of interest (ROI) of the media data that includes an instance of an object class; an encoded masked image frame corresponding to a masked version of the media data; and content protection data, the content protection data including an encryption indicator that indicates the output media data includes the encrypted ROI content; identify the encryption indicator; and based on identification of the encryption indicator: decrypt the encrypted ROI content to obtain the ROI of the media data; and modify the masked version of the media data to include the ROI of the media data, wherein the encoded encrypted ROI frame is indicated as a non-display frame by a non-display indicator.

According to Example 160, an apparatus includes: means for obtaining output media data associated with media data, the output media data including: an encoded encrypted ROI frame corresponding to encrypted ROI content associated with a region of interest (ROI) of the media data that includes an instance of an object class; an encoded masked image frame corresponding to a masked version of the media data; and content protection data, the content protection data including an encryption indicator that indicates the output media data includes the encrypted ROI content; means for identifying the encryption indicator; means for decrypting, based on identification of the encryption indicator, the encrypted ROI content to obtain the ROI of the media data; and means for modifying the masked version of the media data to include the ROI of the media data, wherein the encoded encrypted ROI frame is indicated as a non-display frame by a non-display indicator.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
one or more processors configured to:
obtain input media data including an instance of an object class;
identify a region of interest (ROI) corresponding to the instance of the object class;
extract and encrypt ROI content from the ROI to generate encrypted ROI content;
mask at least a portion of the ROI to generate a masked image frame; and
generate output media data that includes:
an encoded masked image frame corresponding to the masked image frame;
an encoded encrypted ROI frame corresponding to the encrypted ROI content; and
content protection data, the content protection data including an encryption indicator that indicates the output media data includes the encrypted ROI content,
wherein the encoded encrypted ROI frame is indicated as a non-display frame by a non-display indicator.

2. The device of claim 1, wherein the output media data includes a bitstream, and wherein the content protection data is included in metadata of the bitstream, one or more frame headers in the bitstream, or a combination thereof.

3. The device of claim 1, wherein the output media data further includes an encoded segmentation frame corresponding to segmentation data indicating the ROI, and wherein the encoded segmentation frame is indicated as a non-display frame by the non-display indicator.

4. The device of claim 3, wherein the non-display indicator comprises a no-display supplemental enhancement information (SEI) message included in a frame header of at least one of the encoded segmentation frame or the encoded encrypted ROI frame.

5. The device of claim 3, wherein:
the encoded masked image frame includes a first frame header including a display-order frame identifier; and
each of the encoded segmentation frame and the encoded encrypted ROI frame includes a corresponding frame identifier that associates the encoded segmentation frame and the encoded encrypted ROI frame with the encoded masked image frame.

6. The device of claim 3, wherein the encoded segmentation frame includes a segmentation-frame flag indicating that the encoded segmentation frame corresponds to ROI segmentation data.

7. The device of claim 3, wherein the one or more processors are configured to:
combine the segmentation data, the encrypted ROI content, and the masked image frame to generate combined media data; and
provide, to an encoder, the combined media data, one or more encoder settings, or a combination thereof, to generate the output media data.

8. The device of claim 3, wherein the encoded segmentation frame includes ROI identification data identifying one or more ROIs in the segmentation data.

9. The device of claim 8, wherein the ROI identification data includes, for each of the one or more ROIs, a respective ROI global identifier.

10. The device of claim 1, wherein the encoded encrypted ROI frame includes an encrypted-ROI-frame flag indicating that the encoded encrypted ROI frame corresponds to encrypted ROI content.

11. The device of claim 1, wherein the content protection data further includes encryption parameters indicating at least one of an encryption algorithm identifier, an encryption mode, or one or more encryption algorithm parameter values associated with encrypting the ROI content.

12. The device of claim 11, wherein the encryption parameters include cipher text corresponding to an encrypted secret key for decrypting the encrypted ROI content.

13. The device of claim 1, wherein:
the one or more processors are configured to decrypt the encrypted ROI content to obtain decrypted ROI content; and
modify the masked image frame to include the decrypted ROI content based on at least one of segmentation data or position data associated with the ROI.

14. The device of claim 1, wherein the output media data is compliant with a video coding standard and is configured such that a decoder not aware of encryption ignores the encoded encrypted ROI frame based on the non-display indicator.

15. The device of claim 1, wherein:
the one or more processors are configured to generate position data that indicates a position of the portion of the input media data that includes the instance of the object class; and
the output media data includes the position data.

16. The device of claim 1, further comprising a memory coupled to the one or more processors and configured to store a content encryption configuration that indicates the object class, and wherein the one or more processors are configured to detect the instance of the object class in the input media data.

17. The device of claim 16, wherein the one or more processors are configured to store the output media data at the memory.

18. The device of claim 1, further comprising one or more cameras coupled to the one or more processors, and wherein the one or more cameras are configured to generate the input media data.

19. The device of claim 1, further comprising a modem coupled to the one or more processors, the modem configured to transmit the output media data to a decoder device.

20. The device of claim 1, wherein the one or more processors are integrated in a mobile phone, a tablet computer device, a wearable electronic device, a virtual reality headset, a mixed reality headset, an augmented reality headset, or a camera device.

21. The device of claim 1, wherein the one or more processors are integrated in a vehicle.

22. A method comprising:
obtaining, at a device, input media data including an instance of an object class;
identifying, at the device, a region of interest (ROI) corresponding to the instance of the object class;
extracting and encrypting, at the device, ROI content from the ROI to generate encrypted ROI content;
masking, at the device, at least a portion of the ROI to generate a masked image frame; and
generating, at the device, output media data that includes:
an encoded masked image frame corresponding to the masked image frame;
an encoded encrypted ROI frame corresponding to the encrypted ROI content; and
content protection data, the content protection data including an encryption indicator that indicates the output media data includes the encrypted ROI content,
wherein the encoded encrypted ROI frame is indicated as a non-display frame by a non-display indicator.

23. The method of claim 22, wherein the output media data includes a bitstream, and wherein the content protection data is included in metadata of the bitstream, one or more frame headers in the bitstream, or a combination thereof.

24. A device comprising:
one or more processors configured to:
obtain output media data associated with media data, the output media data including:
an encoded encrypted ROI frame corresponding to encrypted ROI content associated with a region of interest (ROI) of the media data that includes an instance of an object class;
an encoded masked image frame corresponding to a masked version of the media data; and
content protection data, the content protection data including an encryption indicator that indicates the output media data includes the encrypted ROI content;
identify the encryption indicator; and
based on identification of the encryption indicator:
decrypt the encrypted ROI content to obtain the ROI of the media data; and
modify the masked version of the media data to include the ROI of the media data,
wherein the encoded encrypted ROI frame is indicated as a non-display frame by a non-display indicator.

25. The device of claim 24, wherein the output media data includes a bitstream, and wherein the content protection data is included in metadata of the bitstream, one or more frame headers in the bitstream, or a combination thereof.

26. The device of claim 24, wherein the one or more processors are configured to modify the masked version based on segmentation data included in the output media data.

27. The device of claim 24, further comprising a display device coupled to the one or more processors and configured to output display data based on the output media data.

28. A method comprising:
obtaining, at a device, output media data associated with media data, the output media data including:
an encoded encrypted ROI frame corresponding to encrypted ROI content associated with a region of interest (ROI) of the media data that includes an instance of an object class;
an encoded masked image frame corresponding to a masked version of the media data; and
content protection data, the content protection data including an encryption indicator that indicates the output media data includes the encrypted ROI content;
identifying, at the device, the encryption indicator;
decrypting, at the device and based on identification of the encryption indicator, the encrypted ROI content to obtain the ROI of the media data; and
modifying, at the device and based on identification of the encryption indicator, the masked version of the media data to include the ROI of the media data,
wherein the encoded encrypted ROI frame is indicated as a non-display frame by a non-display indicator.

29. The method of claim 28, wherein the output media data includes a bitstream, and wherein the content protection data is included in metadata of the bitstream, one or more frame headers in the bitstream, or a combination thereof.

30. The method of claim 28, wherein modifying the masked version is based on segmentation data included in the output media data.
